(19) United States
(12) Patent Application Publication
(10) Pub. No.: US 2025/0383658 A1
(43) Pub. Date: Dec. 18, 2025

(54) CONTROL DEVICE, MOBILE BODY, AND MANIPULATION SYSTEM

(71) Applicant: SONY GROUP CORPORATION, TOKYO (JP)

(72) Inventors: SHINICHIRO ABE, TOKYO (JP); KOHEI URUSHIDO, TOKYO (JP)

(21) Appl. No.: 18/878,665

(22) PCT Filed: Jun. 29, 2023
(86) PCT No.: PCT/JP2023/024193

§ 371 Date: Dec. 24, 2024

(30) Foreign Application Priority Data
Jul. 6, 2022 (JP) 2022-109345

(51) Int. Cl. G05D 1/224; G05D 1/246; G05D 101/00; G05D 109/20

(52) U.S. Cl. CPC G05D 1/2244; G05D 1/246; G05D 2101/22; G05D 2109/20

(57) ABSTRACT

A control device according to one aspect of the present disclosure is a device that remotely operates a mobile body. The control device includes an operation unit and a sensor unit. The operation unit that performs reception of an operation for the mobile body. The sensor unit performs detection of a posture of the control device or the mobile body. The control device further includes a generation unit and a communication unit. The generation unit generates posture data of the control device on the basis of a result of the detection performed by the sensor unit. The communication unit transmits, to the mobile body, the posture data generated by the generation unit and operation data obtained by the reception performed by the operation unit.

### TECHNICAL FIELD

The present disclosure relates to a control device, a mobile body, and a manipulation system.

### BACKGROUND ART

A technique of manipulating a mobile body such as a drone has been disclosed (for example, PTL 1).

### CITATION LIST

### Patent Literature

PTL 1: Japanese Unexamined Patent Application Publication No. 2016-149090

### SUMMARY OF THE INVENTION

In a remote operation of a mobile body, an operation with use of a remote controller is performed with a nose direction of the mobile body regarded as a forward movement direction. It is therefore difficult for an operator who is not familiar with the operation to remotely operate the mobile body. Accordingly, it is desirable to provide a control device, a mobile body, and a manipulation system that each allow for intuitive remote control of a mobile body.

A control device according to a first aspect of the present disclosure is a device that remotely operates a mobile body. The control device includes an operation unit and a sensor unit. The operation unit performs reception of an operation for the mobile body. The sensor unit performs detection of a posture of the control device or the mobile body. The control device further includes a generation unit and a communication unit. The generation unit generates posture data of the control device on the basis of a result of the detection performed by the sensor unit. The communication unit transmits, to the mobile body, the posture data generated by the generation unit and operation data received by the operation unit.

A mobile body according to a second aspect of the present disclosure is to be remotely operated by a control device. The mobile body includes a sensor unit, a generation unit, and a communication unit. The sensor unit performs detection of a posture of the mobile body. The generation unit generates posture data of the mobile body on the basis of a result of the detection performed by the sensor unit. The communication unit receives posture data of the control device and operation data of the mobile body from the control device. The mobile body further includes a correction unit. The correction unit performs correction on the operation data of the mobile body received by the communication unit, on the basis of the posture data of the control device received by the communication unit and the posture data of the mobile body generated by the generation unit, and thereby generates corrected operation data. The mobile body further includes a control unit. The control unit controls an actuator on the basis of the corrected operation data generated by the correction performed by the correction unit.

A mobile body according to a third aspect of the present disclosure is to be remotely operated by a control device. The mobile body includes a sensor unit, a generation unit, and a communication unit. The sensor unit performs detection of a posture of the control device or an object in a corresponding relationship with the control device. The generation unit generates posture data of the mobile body on the basis of a result of the detection performed by the sensor unit. The communication unit receives movement data of the control device and operation data of the mobile body from the control device. The mobile body further includes a correction unit. The correction unit performs correction on the operation data of the mobile body received by the communication unit, on the basis of the posture data of the control device received by the communication unit and the posture data of the mobile body generated by the generation unit, and thereby generates corrected operation data. The mobile body further includes a control unit. The control unit controls an actuator on the basis of the corrected operation data generated by the correction performed by the correction unit.

A manipulation system according to a fourth aspect of the present disclosure includes a mobile body and a control device. The control device remotely operates the mobile body. The control device includes an operation unit, a first sensor unit, a first generation unit, and a first communication unit. The operation unit performs reception of an operation for the mobile body. The first sensor unit performs detection of a posture of the control device. The first generation unit generates posture data of the control device on the basis of a result of the detection performed by the first sensor unit. The first communication unit transmits, to the mobile body, the posture data generated by the first generation unit and operation data received by the operation unit. The mobile body includes a second sensor unit, a second generation unit, and a second communication unit. The second sensor unit performs detection of a posture of the mobile body. The second generation unit generates posture data of the mobile body on the basis of a result of the detection performed by the second sensor unit. The second communication unit receives the posture data of the control device and the operation data of the mobile body from the control device. The mobile body further includes a correction unit. The correction unit performs correction on the operation data of the mobile body received by the second communication unit, on the basis of the posture data of the control device received by the second communication unit and the posture data of the mobile body generated by the second generation unit, and thereby generates corrected operation data. The mobile body further includes a driving unit. The driving unit drives an actuator on the basis of the corrected operation data generated by the correction performed by the correction unit.

A manipulation system according to a fifth aspect of the present disclosure includes a mobile body and a control device. The control device remotely operates the mobile body. The control device includes an operation unit, a first sensor unit, a first generation unit, and a first communication unit. The operation unit performs reception of an operation for the mobile body. The first sensor unit performs detection of a posture of the mobile body. The first generation unit generates posture data of the control device on the basis of a result of the detection performed by the first sensor unit. The first communication unit transmits, to the mobile body, the posture data generated by the first generation unit and operation data received by the operation unit. The mobile body includes a second sensor unit, a second generation unit, and a second communication unit. The second sensor unit performs detection of a posture of the control device or an object in a corresponding relationship with the control device. The second generation unit generates posture data of the mobile body on the basis of a result of the detection performed by the second sensor unit. The second communication unit receives movement data of the control device and the operation data of the mobile body from the control device. The mobile body further includes a correction unit. The correction unit performs correction on the operation data of the mobile body received by the second communication unit, on the basis of the movement data of the control device received by the second communication unit and the posture data of the mobile body generated by the second generation unit, and thereby generates corrected operation data. The mobile body further includes a driving unit. The driving unit drives an actuator on the basis of the corrected operation data generated by the correction performed by the correction unit.

### BRIEF DESCRIPTION OF DRAWINGS

FIG. 1 is a diagram illustrating a schematic configuration example of a manipulation system according to a first embodiment of the present disclosure.

(A) of FIG. 2 is a diagram illustrating an example of an operating method of a remote controller in FIG. 1. (B) of FIG. 2 is a diagram illustrating an example of an operating method of an aircraft in FIG. 1.

FIG. 3 is a diagram for describing a remote operation of the aircraft in FIG. 1 by the remote controller in FIG. 1.

FIG. 4 is a diagram for describing the remote operation of the aircraft in FIG. 1 by the remote controller in FIG. 1.

FIG. 5 is a diagram illustrating a schematic configuration example of the remote controller in FIG. 1.

FIG. 6 is a diagram illustrating a schematic configuration example of the aircraft in FIG. 1.

FIG. 7 is a diagram illustrating a display example of the remote controller in FIG. 1.

FIG. 8 is a diagram illustrating a display example of the remote controller in FIG. 1.

FIG. 9 is a diagram illustrating a display example of the remote controller in FIG. 1.

FIG. 10 is a diagram illustrating a display example of the remote controller in FIG. 1.

FIG. 11 is a diagram illustrating an example of a posture control procedure in the remote controller in FIG. 1.

FIG. 12 is a diagram illustrating an example of a posture control procedure in the aircraft in FIG. 1.

FIG. 13 is a diagram illustrating a modification example of a schematic configuration of the manipulation system in FIG. 1.

FIG. 14 is a diagram illustrating an example of a schematic configuration of a remote controller and a terminal device in FIG. 13.

FIG. 15 is a diagram illustrating a schematic configuration example of a manipulation system according to a second embodiment of the present disclosure.

FIG. 16 is a diagram illustrating a schematic configuration example of a remote controller in FIG. 15.

FIG. 17 is a diagram illustrating a schematic configuration example of an aircraft in

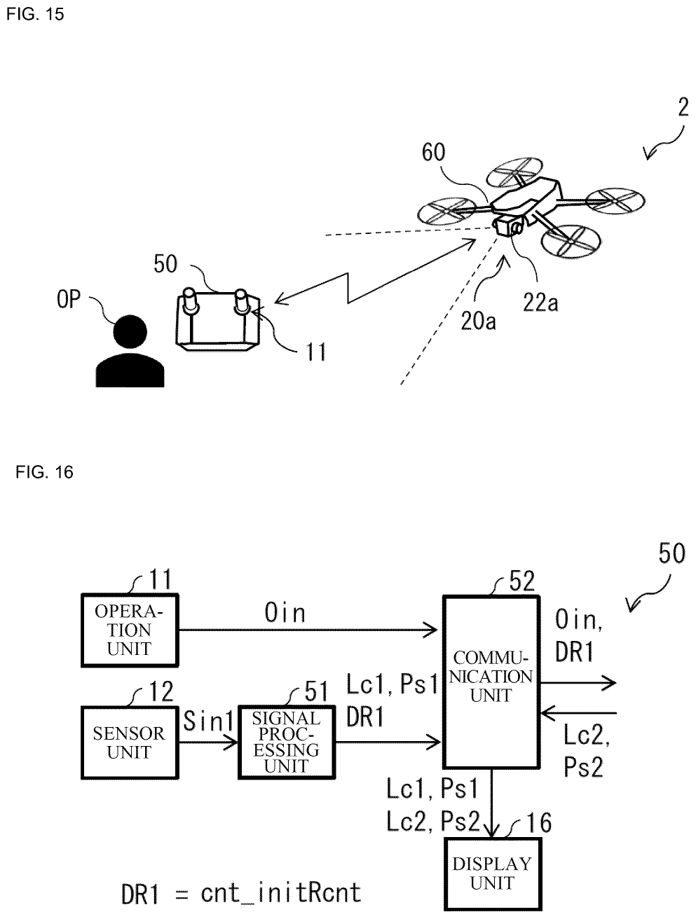

FIG. 15.

FIG. 18 is a diagram illustrating a schematic configuration example of a manipulation system according to a third embodiment of the present disclosure.

FIG. 19 is a diagram illustrating a schematic configuration example of a remote controller of FIG. 18.

FIG. 20 is a diagram illustrating a schematic configuration example of an aircraft in FIG. 18.

FIG. 21 is a diagram illustrating a schematic configuration example of a manipulation system according to a fourth embodiment of the present disclosure.

FIG. 22 is a diagram illustrating an example of posture data acquired from each aircraft in formation in FIG. 21.

FIG. 23 is a diagram illustrating an example of a schematic configuration of a master in FIG. 21.

FIG. 24 is a diagram illustrating an example of a schematic configuration of a slave in FIG. 21.

FIG. 25 is a diagram illustrating an example of an abnormal aircraft detection procedure in the master in FIG. 21.

### MODES FOR CARRYING OUT THE INVENTION

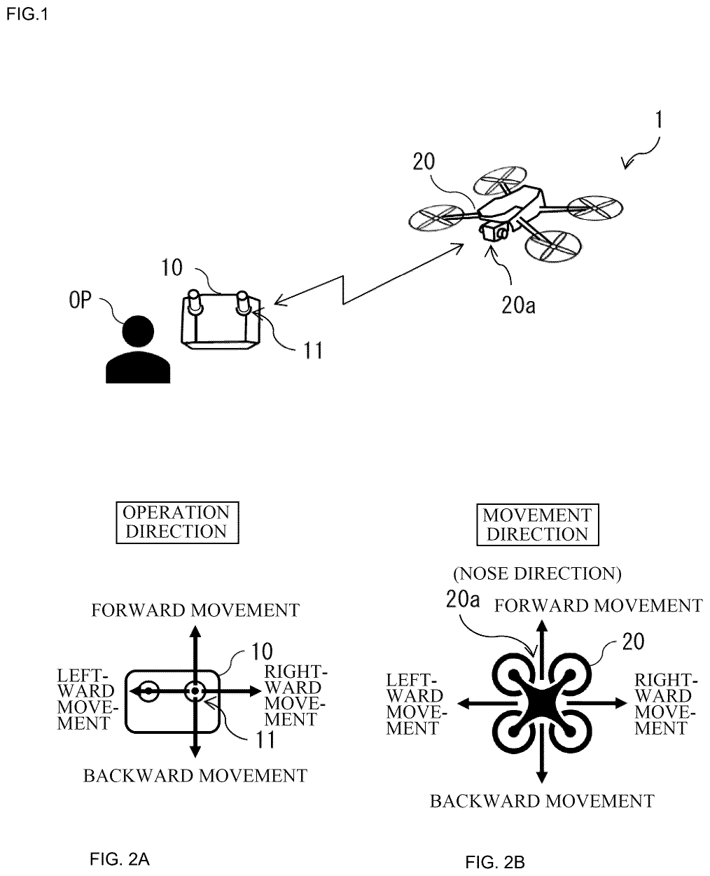

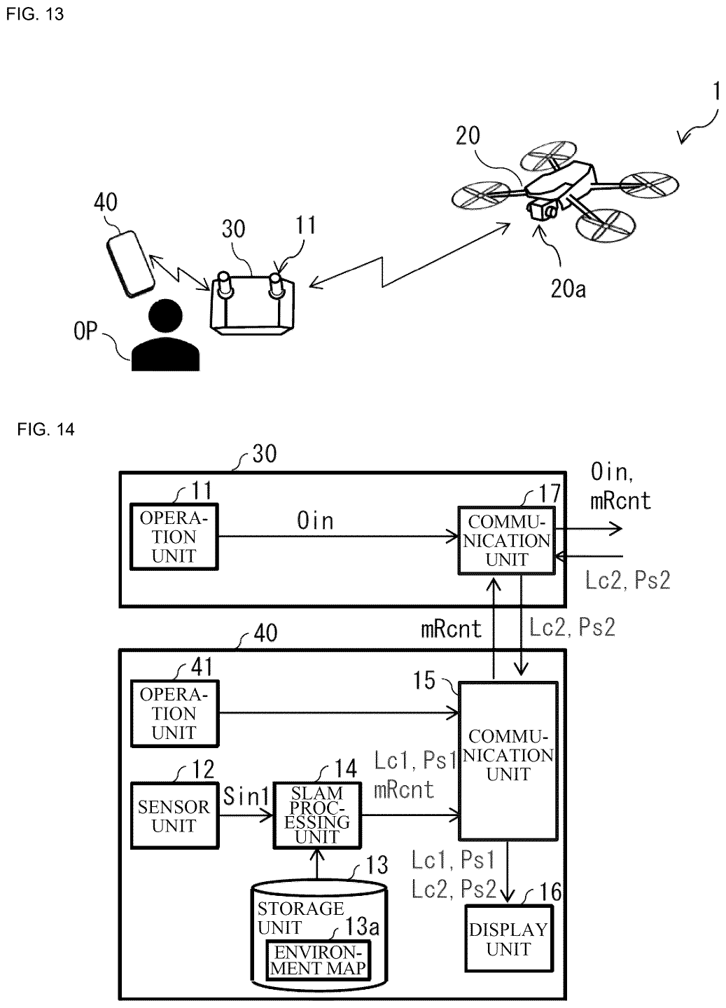

Some embodiments of the present disclosure are described below in detail with reference to the drawings. Note that the description will be given in the following order.
1. First Embodiment (FIGS. 1 to 12)
2. Modification Example of First Embodiment (FIGS. 13 and 14)
3. Second Embodiment (FIGS. 15 to 17)
4. Third Embodiment (FIGS. 18 to 20)
5. Fourth Embodiment (FIGS. 21 to 25)

### 1. First Embodiment

### Configuration

A description is given of a manipulation system 1 according to a first embodiment of the present disclosure. FIG. 1 illustrates a schematic configuration example of the manipulation system 1. For example, as illustrated in FIG. 1, the manipulation system 1 includes an aircraft 20 and a remote controller 10 that remotely operates the aircraft 20. The remote controller 10 corresponds to one specific example of a “control device” of the present disclosure. The aircraft 20 corresponds to one specific example of a “mobile body” of the present disclosure. The manipulation system 1 corresponds to one specific example of a “manipulation system” of the present disclosure.

In the manipulation system 1, an operator OP operates an operation unit 11 of the remote controller 10, and the aircraft 20 is thus remotely controlled by an operation signal transmitted from the remote controller 10. The operation unit 11 has, for example, a stick shape as illustrated in FIG. 1, and is configured to be, for example, pushed down in four directions including an up side, a down side, a right side, and a left side of a main body of the remote controller 10, as illustrated in (A) of FIG. 2.

In a case where the operator OP pushes down the operation unit 11 (a stick) toward the up side of the main body of the remote controller 10, the operation unit 11 outputs a forward movement signal as the operation signal. In a case where the operator OP pushes down the operation unit 11 (the stick) toward the down side of the main body of the remote controller 10, the operation unit 11 outputs a backward movement signal as the operation signal. In a case where the operator OP pushes down the operation unit 11 (the stick) toward the right side of the main body of the remote controller 10, the operation unit 11 outputs a rightward movement signal as the operation signal. In a case where the operator OP pushes down the operation unit 11 (the stick) toward the left side of the main body of the remote controller 10, the operation unit 11 outputs a leftward movement signal as the operation signal.

### [Normal Operation Mode]

A normal operation mode refers to a mode in which a forward movement direction of the operation unit 11 and a forward movement direction of the aircraft 20 coincide with each other. In this case, when the aircraft 20 receives the forward movement signal from the remote controller 10 as the operation signal, the aircraft 20 moves in the forward movement direction (i.e., a nose direction) of the aircraft 20. In addition, when the aircraft 20 receives the backward movement signal from the remote controller 10 as the operation signal, the aircraft 20 moves in a backward movement direction (i.e., a direction opposite to the nose direction) of the aircraft 20. In addition, when the aircraft 20 receives the rightward movement signal from the remote controller 10 as the operation signal, the aircraft 20 moves in a rightward movement direction of the aircraft 20. In addition, when the aircraft 20 receives the leftward movement signal from the remote controller 10 as the operation signal, the aircraft 20 moves in a leftward movement direction of the aircraft 20.

Here, the “nose” refers to a front part of the aircraft 20 (a part corresponding to a nose 20a in FIG. 1). The front part of the aircraft 20 is uniquely defined by each manufacturer of the aircraft 20. For example, in the aircraft 20, the front part of the aircraft 20 may refer to a tip part, in a front direction, of a camera mounted on the aircraft 20, or may refer to a pilot lamp part provided on the aircraft 20. In any case, the nose of the aircraft 20 has a configuration recognizable by the operator OP even from a distance.

### [Intuitive Operation Mode]

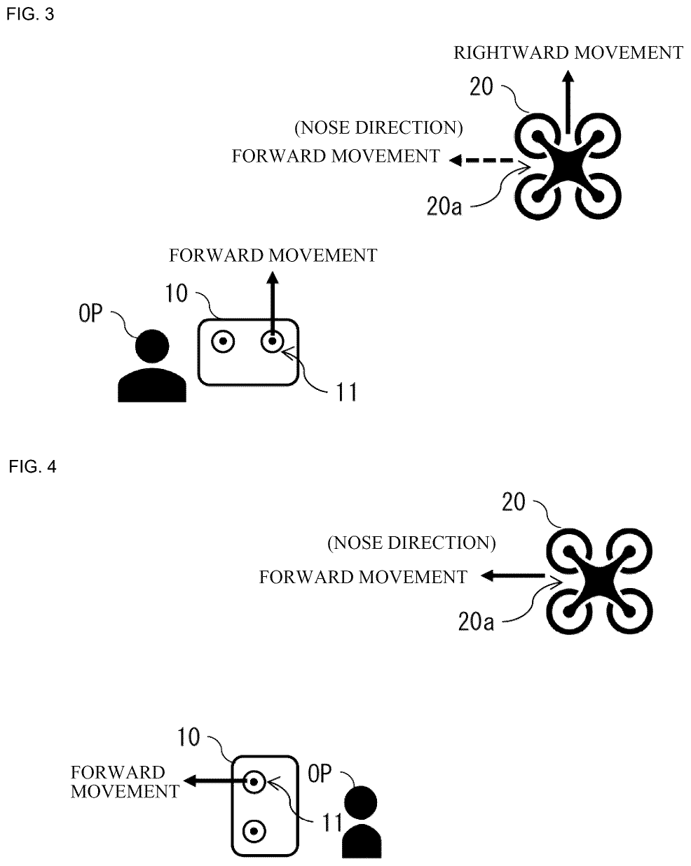

An intuitive operation mode refers to a mode in which an operation direction of the operation unit 11 and a movement direction of the aircraft 20 coincide with each other. Assume that, for example, as illustrated in FIG. 3, the aircraft 20 has a posture in which the forward movement direction of the operation unit 11 and the rightward movement direction of the aircraft 20 coincide with each other. In this case, when the aircraft 20 receives the forward movement signal from the remote controller 10 as the operation signal, the aircraft 20 moves in the rightward movement direction (i.e., a direction different from the nose direction) of the aircraft 20. In addition, when the aircraft 20 receives the backward movement signal from the remote controller 10 as the operation signal, the aircraft 20 moves in the leftward movement direction of the aircraft 20. In addition, when the aircraft 20 receives the rightward movement signal from the remote controller 10 as the operation signal, the aircraft 20 moves in the backward movement direction of the aircraft 20. In addition, when the aircraft 20 receives the leftward movement signal from the remote controller 10 as the operation signal, the aircraft 20 moves in the frontward movement direction (the nose direction) of the aircraft 20.

Here, assume that the operator OP turns to the left by 90° as illustrated in FIG. 4, for example. In this case, when the aircraft 20 receives the forward movement signal from the remote controller 10 as the operation signal, the aircraft 20 moves in the rightward movement direction (i.e., the direction different from the nose direction) of the aircraft 20. In addition, when the aircraft 20 receives the backward movement signal from the remote controller 10 as the operation signal, the aircraft 20 moves in the backward movement direction of the aircraft 20. In addition, when the aircraft 20 receives the rightward movement signal from the remote controller 10 as the operation signal, the aircraft 20 moves in the rightward movement direction of the aircraft 20. In addition, when the aircraft 20 receives the leftward movement signal from the remote controller 10 as the operation signal, the aircraft 20 moves in the leftward movement direction of the aircraft 20.

### [Remote Controller 10]

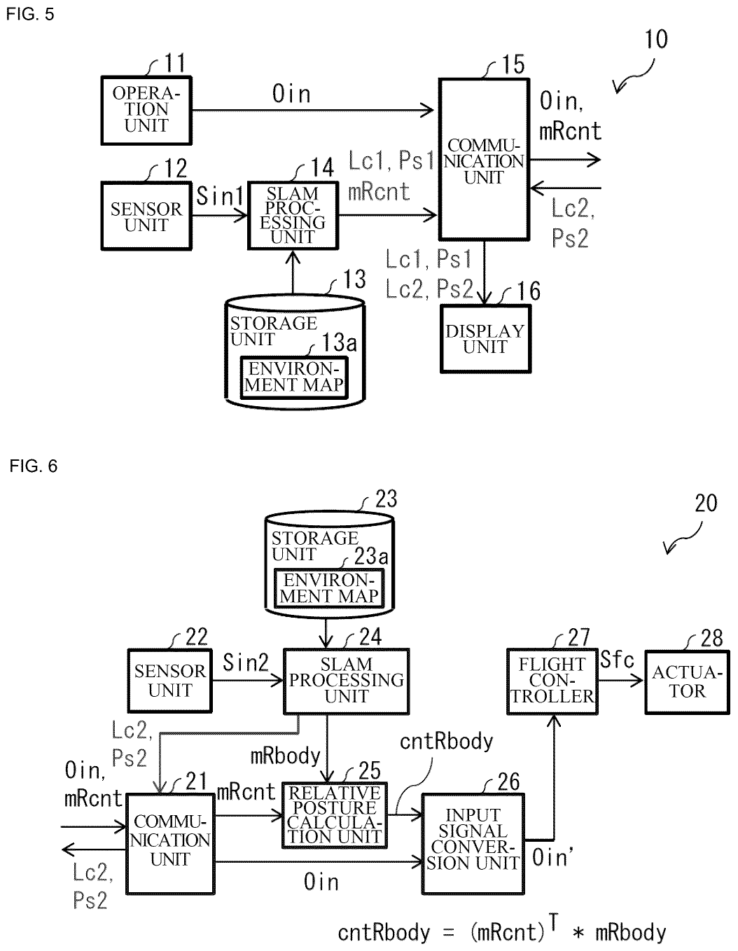

FIG. 5 illustrates a schematic configuration example of the remote controller 10. The remote controller 10 includes the operation unit 11, a sensor unit 12, a storage unit 13, a SLAM (Simultaneous Localization And Mapping) processing unit 14, a communication unit 15, and a display unit 16.

The operation unit 11 is an interface that receives an operation for the aircraft 20 from the operator OP. The operation unit 11 generates, on the basis of an operation by the operator OP, an operation signal Oin for remotely operating the aircraft 20. The operation signal Oin corresponds to one specific example of “operation data” of the present disclosure. The operation unit 11 outputs the generated operation signal Oin to the communication unit 15. The operation signal Oin is expressed in a coordinate system of an environment map 13a stored in the storage unit 13. For example, the operation signal Oin includes a motion vector expressed in the coordinate system of the environment map 13a.

The sensor unit 12 includes, for example, a sensor device that recognizes an external environment and acquires environment data corresponding to the recognized external environment. Examples of the sensor device include an RGB camera, an RGB-D camera, a depth sensor, an infrared sensor, an event-based camera, and a stereo camera.

The RGB camera is, for example, a single-application visible-light image sensor, and outputs RGB image data obtained by receiving visible light and converting the received visible light into an electric signal. The RGB-D camera is, for example, a binocular visible-light image sensor, and outputs RGB-D image data (RGB image data and a distance image data obtained on the basis of a parallax). The depth sensor is, for example, a ToF (Time of Flight) sensor or a Lider (Laser Imaging Detection and Ranging), and outputs distance image data obtained by measuring scattered light with respect to pulsed laser irradiation. The infrared sensor outputs, for example, infrared image data obtained by receiving infrared light and converting the received infrared light into an electric signal. The event-based camera is, for example, a single-application visible-light image sensor, and outputs a difference (difference image data) in RGB image data between frames. The stereo camera is, for example, a binocular visible-light image sensor, and outputs distance image data obtained from two pieces of RGB image data different in viewpoint. The sensor device outputs, for example, image data obtained from the external environment (e.g., the RGB image data, the RGB-D image data, the distance image data, the infrared image data, or the difference image data) as the environment data.

In addition, the sensor unit 12 detects a position and a posture of the remote controller 10. The sensor unit 12 includes a positioning meter, for example. The positioning meter receives a GNSS (Global Navigation Satellite System) signal from a GNSS satellite (e.g., a GPS (Global Positioning System) signal from a GPS satellite), executes positioning, and generates position data including a latitude, a longitude, and an altitude of the remote controller 10. The sensor unit 12 further includes a gyro sensor, for example. The gyro sensor detects an angular velocity of the remote controller 10, and generates posture data of the remote controller 10 on the basis of the detected angular velocity.

The sensor unit 12 outputs, for example, sensor data Sin1 to the SLAM processing unit 14. The sensor data Sin1 includes, for example, the environment data, the position data of the remote controller 10, and the posture data of the remote controller 10 described above.

The storage unit 13 includes, for example, a volatile memory such as a DRAM (Dynamic Random Access Memory) or a nonvolatile memory such as an EEPROM (Electrically Erasable Programmable Read-Only Memory) or a flash memory. The storage unit 13 holds the environment map 13a, for example.

For example, the SLAM processing unit 14 constructs a surrounding map on the basis of the senser data Sin1 obtained from the sensor unit 12, and generates a new map by superimposing the constructed surrounding map on the environment map 13a read from the storage unit 13. For example, the SLAM processing unit 14 stores the generated new map in the environment map 13a in the storage unit 13, and updates the environment map 13a.

The SLAM processing unit 14 derives the position and the posture of the remote controller 10 on the basis of the sensor data Sin1 obtained from the sensor unit 12. The derived position and posture of the remote controller 10 are expressed in the coordinate system of the environment map 13a. For example, the SLAM processing unit 14 generates position data Lc1 expressed in the coordinate system of the environment map 13a, on the basis of the position data obtained from the positioning meter of the sensor unit 12. For example, the SLAM processing unit 14 generates posture data Ps1 and a rotation matrix mRcnt expressed in the coordinate system of the environment map 13a, on the basis of the posture data obtained from the gyro sensor of the sensor unit 12. The SLAM processing unit 14 outputs the generated position data Lc1, the generated posture data Ps1, and the generated rotation matrix mRcnt to the communication unit 15. Note that in a case where the SLAM processing unit 14 is somehow unable to generate the rotation matrix mRcnt, the SLAM processing unit 14 generates a normal operation mode transition notification and outputs the generated normal operation mode transition notification to the communication unit 15.

Here, in mRcnt, m positioned on left side of R means that it is based on the coordinate system of the environment map 13a as a reference, R means that it is a rotation matrix, and cnt positioned on right side of R means the remote controller 10. That is, mRcnt means that it is a rotation matrix representing the posture of the remote controller 10 in the coordinate system of the environment map 13a.

The communication unit 15 transmits, to the aircraft 20, the operation signal Oin generated by the operation unit 11 and the rotation matrix mRcnt generated by the SLAM processing unit 14. The communication unit 15 receives, from the aircraft 20, position data Lc2 and posture data Ps2 of the aircraft 20. The position data Lc2 and the posture data Ps2 are each data generated by a SLAM processing unit 24 (which will be described later) of the aircraft 20. The communication unit 15 outputs, to the display unit 16, the position data Lc1 and the posture data Ps1 of the remote controller 10 and the position data Lc2 and the posture data Ps2 of the aircraft 20. Note that in a case where the communication unit 15 acquires the normal operation mode transition notification from the SLAM processing unit 14, the communication unit 15 outputs the normal operation mode transition notification to the aircraft 20 and the display unit 16.

The display unit 16 includes a picture signal generator and a display panel. The picture signal generator generates image data indicating the respective positions and the respective postures of the remote controller 10 and the aircraft 20, on the basis of the position data Lc1 and the posture data Ps1 of the remote controller 10 and the position data Lc2 and the posture data Ps2 of the aircraft 20. The picture signal generator outputs the generated image data to the display panel. The display panel displays a picture (at least an orientation of the aircraft 20, out of the orientation of the aircraft 20 and an orientation of the remote controller 10) based on the inputted image data.

### [Aircraft 20]

FIG. 6 illustrates a schematic configuration example of the aircraft 20. The aircraft 20 is to be remotely operated by the remote controller 10. The aircraft 20 includes a communication unit 21, a sensor unit 22, a storage unit 23, the SLAM processing unit 24, a relative posture calculation unit 25, an input signal conversion unit 26, a flight controller 27, and an actuator 28.

The communication unit 21 receives the operation signal Oin and the rotation matrix mRcnt from the remote controller 10. The communication unit 21 outputs the received operation signal Oin to the input signal conversion unit 26, and outputs the received rotation matrix mRcnt to the relative posture calculation unit 25. Further, the communication unit 21 acquires the position data Lc2 and the posture data Ps2 of the aircraft 20 from the SLAM processing unit 24. The communication unit 21 transmits the acquired position data Lc2 and the acquired posture data Ps2 to the remote controller 10. Note that in a case where the communication unit 21 acquires the normal operation mode transition notification from the remote controller 10, the communication unit 21 outputs the normal operation mode transition notification to the input signal conversion unit 26.

The sensor unit 22 includes, for example, a sensor device that recognizes the external environment, and acquires environment data corresponding to the recognized external environment. Examples of the sensor device include an RGB camera, an RGB-D camera, a depth sensor, an infrared sensor, an event-based camera, and a stereo camera. These sensors and cameras have respective configurations similar to those of the sensors and cameras usable in the sensor unit 12.

In addition, the sensor unit 22 detects a position and a posture of the aircraft 20. The sensor unit 22 includes a positioning meter, for example. The positioning meter receives a GNSS signal from a GNSS satellite (e.g., a GPS signal from a GPS satellite), executes positioning, and generates position data including a latitude, a longitude, and an altitude of the aircraft 20. The sensor unit 22 further includes a gyro sensor, for example. The gyro sensor detects an angular velocity of the aircraft 20, and generates posture data of the aircraft 20 on the basis of the detected angular velocity.

The sensor unit 22 outputs, for example, sensor data Sin2 to the SLAM processing unit 24. The sensor data Sin2 includes, for example, the environment data, the position data of the aircraft 20, and the posture data of the aircraft 20 described above.

The storage unit 23 includes, for example, a volatile memory such as a DRAM, or a nonvolatile memory such as an EEPROM or a flash memory. The storage unit 23 holds the environment map 23a, for example.

For example, the SLAM processing unit 24 constructs a surrounding map on the basis of the senser data Sin2 obtained from the sensor unit 22, and generates a new map by superimposing the constructed surrounding map on the environment map 23a read from the storage unit 23. For example, the SLAM processing unit 24 stores the generated new map in the environment map 23a in the storage unit 23, and updates the environment map 23a.

The SLAM processing unit 24 derives the position and the posture of the aircraft 20 on the basis of the sensor data Sin2 obtained from the sensor unit 22. The derived position and posture of the aircraft 20 are expressed in a coordinate system of the environment map 23a. The coordinate system of the environment map 23a is the same as the coordinate system of the environment map 13a. For example, the SLAM processing unit 24 generates the position data Lc2 expressed in the coordinate system of the environment map 23a, on the basis of the position data obtained from the positioning meter of the sensor unit 22. For example, the SLAM processing unit 24 generates the posture data Ps2 and a rotation matrix mRbody expressed in the coordinate system of the environment map 23a, on the basis of the posture data obtained from the gyro sensor of the sensor unit 22. The SLAM processing unit 24 outputs the generated position data Lc2 and the generated posture data Ps2 to the communication unit 21, and outputs the generated rotation matrix mRbody to the relative posture calculation unit 25. Note that in a case where the SLAM processing unit 24 is somehow unable to generate the rotation matrix mRbody, the SLAM processing unit 24 generates the normal operation mode transition notification, and outputs the normal operation mode transition notification to the input signal conversion unit 26.

Here, in mRbody, m positioned on left side of R means that it is based on the coordinate system of the environment map 23a as a reference, R means that it is a rotation matrix, and body positioned on right side of R means the aircraft 20. That is, mRbody means that it is a rotation matrix representing the posture of the aircraft 20 in the coordinate system of the environment map 23a.

The relative posture calculation unit 25 estimates a relative posture of the aircraft 20 with respect to the remote controller 10 on the basis of the rotation matrix mRcnt inputted from the communication unit 21 and the rotation matrix mRbody inputted from the SLAM processing unit 24. The relative posture calculation unit 25 calculates a rotation matrix cntRbody as relative posture data of the aircraft 20 with respect to the remote controller 10 by using Expression (1), for example. In Expression (1), (mRcnt)^{T} is a transposed matrix of mRcnt.

$$cntRbody = {( mRcnt )}^{T} \times mRbody \qquad ( 1 )$$

Here, in cntRbody, cnt positioned on left side of R means that it is based on the posture of the remote controller 10 as a reference, R means that it is a rotation matrix, and body positioned on right side of R means the aircraft 20. That is, cntRbody means that it is a rotation matrix representing the relative posture of the aircraft 20 viewed from the remote controller 10.

The relative posture calculation unit 25 outputs, to the input signal conversion unit 26, the relative posture of the aircraft 20 with respect to the remote controller 10 obtained by the estimation. The relative posture calculation unit 25 outputs, for example, the rotation matrix cntRbody obtained by the calculation to the input signal conversion unit 26.

The input signal conversion unit 26 converts the operation signal Oin inputted from the communication unit 21 into a relative operation signal Oin′ on the basis of the rotation matrix cntRbody inputted from the relative posture calculation unit 25. That is, the input signal conversion unit 26 corrects the operation signal Oin on the basis of the posture data Lc1 of the remote controller 10 and the posture data Lc2 of the aircraft 20, and thereby generates the relative operation signal Oin′. The input signal conversion unit 26 outputs the generated relative operation signal Oin′ to the flight controller 27. Note that in a case where the input signal conversion unit 26 acquires the normal operation mode transition notification from the communication unit 21 or the SLAM processing unit 24, the input signal conversion unit 26 outputs the operation signal Oin to the flight controller 27 as it is.

The flight controller 27 controls the actuator 28 on the basis of the relative operation signal Oin′ (the operation signal Oin in the normal operation mode). The flight controller 27 generates a control signal sfc on the basis of the relative operation signal Oin′ (the operation signal Oin in the normal operation mode), and outputs the generated control signal sfc to the actuator 28. The actuator 28 causes a propeller of the aircraft 20 to rotate, on the basis of the control signal sfc inputted from the flight controller 27. The flight controller 27 thus performs a posture control of the aircraft 20 on the basis of the relative operation signal Oin′ (the operation signal Oin in the normal operation mode).

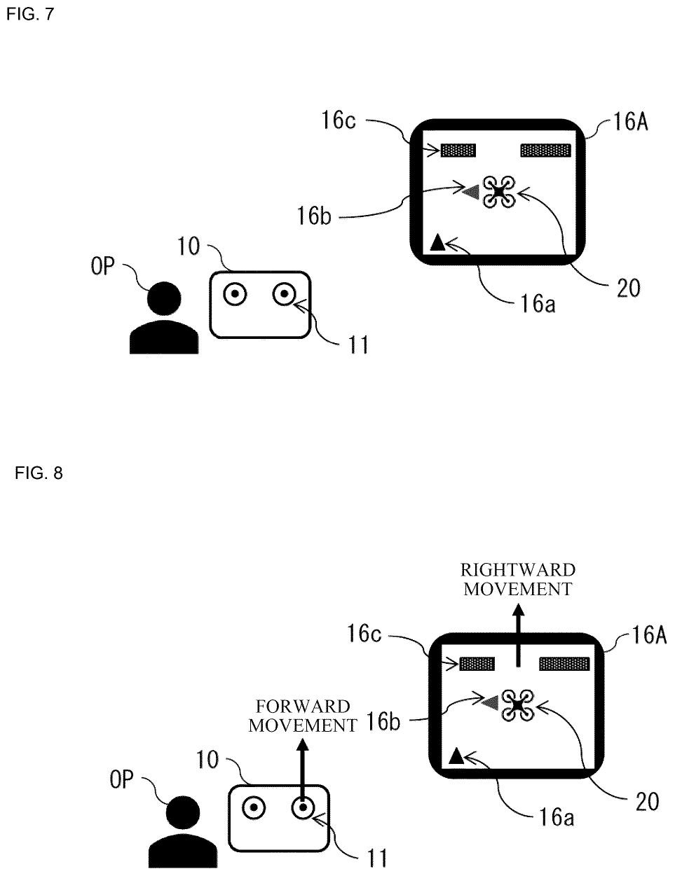

FIG. 7 illustrates a display example of a display screen 16A of the display unit 16. In FIG. 7, the respective postures of the remote controller 10 and the aircraft 20 are represented by icons (16a and 16b) of triangles on the display screen 16A. In FIG. 7, the posture of the remote controller 10 is represented by the icon 16a of an upward triangle, and the posture of the aircraft 20 is represented by the icon 16b of a leftward triangle. This indicates that the nose 20a of the aircraft 20 is oriented in the leftward movement direction of the remote controller 10. In this case, assume that, for example, as illustrated in FIG. 8, the operator OP moves the operation unit 11 of the remote controller 10 in the forward movement direction. Then, the input signal conversion unit 26 generates the relative operation signal Oin′ in which the operation signal Oin is rotated by 90° in a right rotation direction on the basis of the rotation matrix cntRbody, and outputs the generated relative operation signal Oin′ to the flight controller 27. As a result, the aircraft 20 moves in the same direction (the rightward movement direction) as the operation direction of the operation unit 11 when viewed from the operator OP.

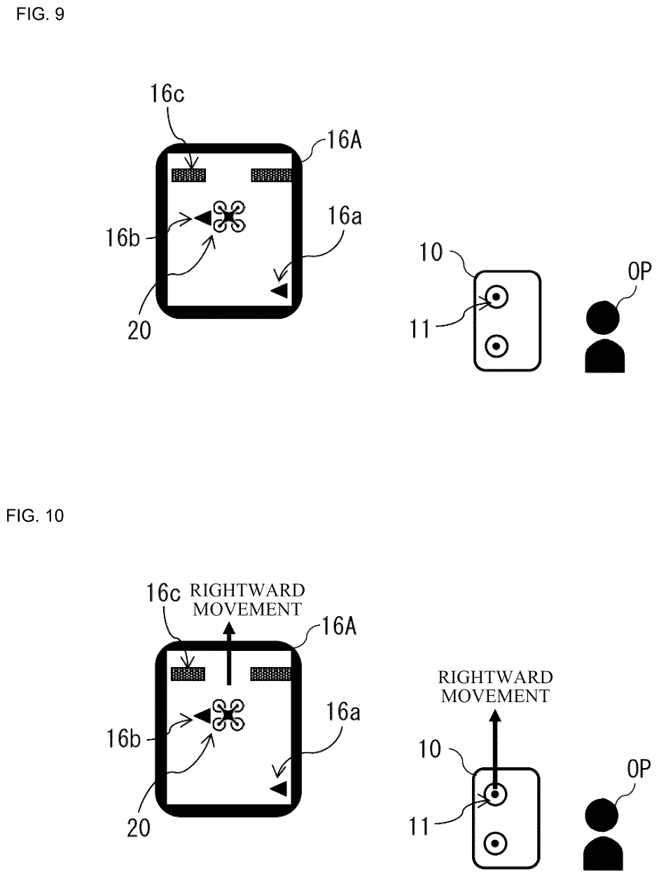

Here, assume that the operator OP turns to the left by 90° as illustrated in FIG. 9, for example. In this case, the posture of the remote controller 10 is represented by the icon 16a of the upward triangle, and the posture of the aircraft 20 is represented by the icon 16b of the upward triangle on the display screen 16A. This indicates that the nose 20a of the aircraft 20 is oriented in the forward movement direction of the remote controller 10. In this case, assume that, for example, as illustrated in FIG. 10, the operator OP moves the operation unit 11 of the remote controller 10 in the forward movement direction. Then, the input signal conversion unit 26 generates the relative operation signal Oin′ in which the operation signal Oin is rotated by 0° in a rotation direction on the basis of the rotation matrix cntRbody, and outputs the generated relative operation signal Oin′ to the flight controller 27. As a result, the aircraft 20 moves in the same direction (the rightward movement direction) as the operation direction of the operation unit 11 when viewed from the operator OP.

### [Operation]

A description is given next of respective operations of the remote controller 10 and the aircraft 20 in the manipulation system 1.

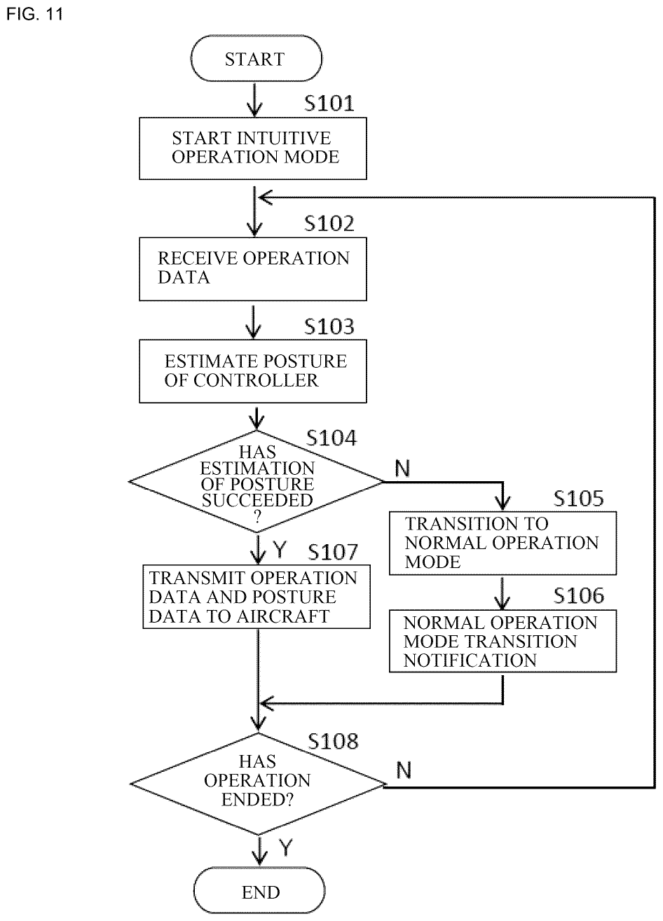

FIG. 11 illustrates an example of a posture control procedure in the remote controller 10. First, the remote controller 10 starts the intuitive operation mode (step S101). When the operation unit 11 receives the operation by the operator OP, the operation unit 11 generates the operation signal Oin corresponding to the received operation, and outputs the generated operation signal Oin to the communication unit 15. The communication unit 15 receives the operation signal Oin (operation data) (step S102).

The SLAM processing unit 14 estimates the posture of the remote controller 10 on the basis of the sensor data Sin1 obtained from the sensor unit 12 (step S103). In a case where the estimation of the posture of the remote controller 10 by the SLAM processing unit 14 has succeeded (step S104; Y), the communication unit 15 transmits the operation signal Oin (the operation data) and the rotation matrix mRcnt (posture data) to the aircraft 20 (step S107). In contrast, in a case where the estimation of the posture of the remote controller 10 by the SLAM processing unit 14 has failed (step S104; N), the SLAM processing unit 14 and the communication unit 15 transition to the normal operation mode (step S105). Further, the display unit 16 notifies the operator OP of the transition to the normal operation mode (step S105).

While the operation by the operator OP continues, the remote controller 10 executes steps S102 to S107 (step S108; N). In a case where the operation by the operator OP has ended, the remote controller 10 ends the operation of the aircraft 20 (step S108; Y).

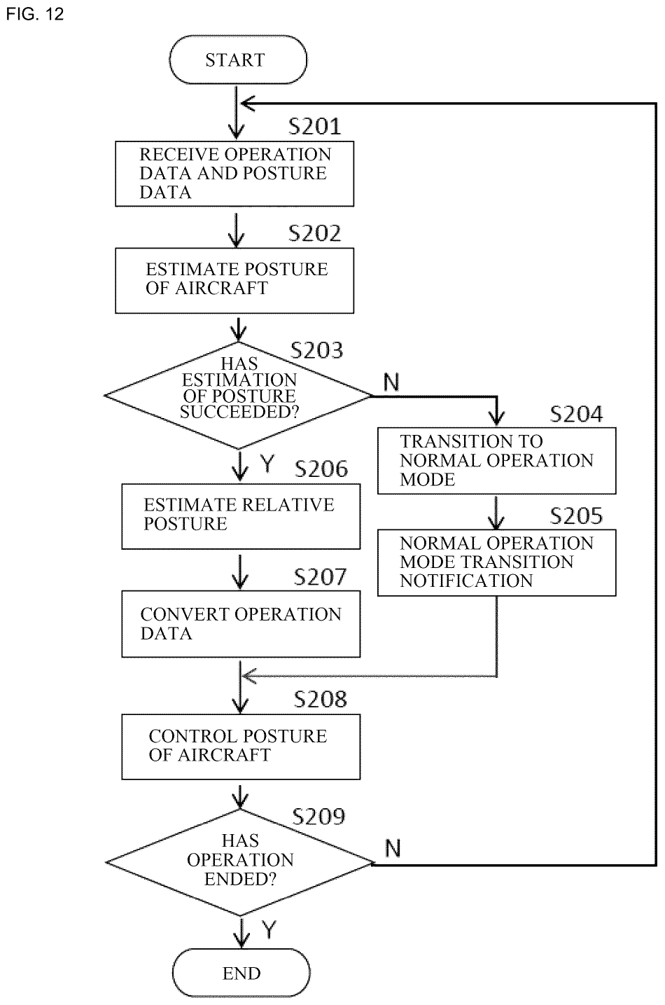

FIG. 12 illustrates an example of a posture control procedure in the aircraft 20. The communication unit 21 receives the operation signal Oin (the operation data) and the rotation matrix mRcnt (the posture data) (step S201).

In this case, the SLAM processing unit 24 estimates the posture of the aircraft 20 on the basis of the sensor data Sin2 obtained from the sensor unit 22 (step S202). In a case where the estimation of the posture of the remote controller 10 by the SLAM processing unit 24 has succeeded (step S203; Y), the relative posture calculation unit 25 estimates the relative posture of the aircraft 20 viewed from the remote controller 10, on the basis of the rotation matrix mRcnt (the posture data) acquired from the communication unit 21 and the rotation matrix mRbody (posture data) generated on the basis of the sensor data Sin2 (step S206). Further, the input signal conversion unit 26 converts the operation signal Oin into the relative operation signal Oin′ on the basis of the relative posture obtained by the estimation (step S207).

In contrast, in a case where the estimation of the posture of the aircraft 20 by the SLAM processing unit 24 has failed (step S203; N), the SLAM processing unit 24 transitions to the normal operation mode (step S204). In this case, the SLAM processing unit 24 generates the normal operation mode transition notification, and transmits the generated normal operation mode transition notification to the remote controller 10 via the communication unit 21 (step S205). As a result, the display unit 16 of the remote controller 10 notifies the operator OP of the transition to the normal operation mode.

The flight controller 27 performs the posture control of the aircraft 20 on the basis of the relative operation signal Oin′ (the operation signal Oin in the normal operation mode) (step S208). While the operation by the operator OP continues, the aircraft 20 executes steps S201 to S208 (step S209; N). In a case where the operation by the operator OP has ended, the aircraft 20 ends the posture control of the aircraft 20 (step S209; Y).

### Effects

Next, a description is given of effects of the manipulation system 1.

In the present embodiment, the posture data (the rotation matrix mRcnt) of the remote controller 10 generated on the basis of a detection result (the sensor data Sin1) in the sensor unit 12 and the operation data (the operation signal Oin) received by the operation unit 11 are transmitted to the aircraft 20. For example, this makes it possible for the aircraft 20 to convert the operation data (the operation signal Oin) into data (the operation signal Oin′) for operating the relative posture of the aircraft 20 viewed from the remote controller 10, on the basis of the posture data (the rotation matrix mRcnt) of the remote controller 10 and the posture data (the rotation matrix mRbody) of the aircraft 20. This allows the operator OP to intuitively perform a remote operation of the aircraft 20.

In the present embodiment, the posture data (the rotation matrix mRcnt) expressed in the coordinate system of the environment map 13a is generated on the basis of the detection result (the sensor data Sin1) in the sensor unit 12 and the environment map 13a. For example, this makes it possible for the aircraft 20 to generate the operation data (the operation signal Oin′) with high accuracy, on the basis of the posture data (the rotation matrix mRcnt) expressed in the coordinate system of the environment map 13a and the posture data (the rotation matrix mRbody) expressed in the coordinate system shared with the environment map 13a. This allows the operator OP to intuitively perform the remote operation of the aircraft 20.

In the present embodiment, the respective orientations (the respective postures) of the remote controller 10 and the aircraft 20 are displayed on the basis of the posture data Ps1 of the remote controller 10 and the posture data Ps2 of the aircraft 20. This allows the operator OP to more intuitively perform the operation of the aircraft 20.

In the present embodiment, the operation data (the operation signal Oin) is corrected on the basis of the posture data (the rotation matrix mRcnt) of the remote controller 10 and the posture data (the rotation matrix mRbody) of the aircraft 20, and the corrected operation data (the operation signal Oin′) is thereby generated. This allows the operator OP to intuitively perform the remote operation of the aircraft 20.

In the present embodiment, the relative posture data (the rotation matrix cntRbody) of the aircraft 20 with respect to the remote controller 10 is generated on the basis of the posture data (the rotation matrix mRcnt) of the remote controller 10 and the posture data (the rotation matrix mRbody) of the aircraft 20. In addition, the corrected operation data (the operation signal Oin′) is generated on the basis of the generated relative posture data (the rotation matrix cntRbody). This allows the operator OP to intuitively perform the remote operation of the aircraft 20.

In the present embodiment, the posture data (the rotation matrix mRbody) expressed in the coordinate system of the environment map 23a is generated on the basis of a detection result (the sensor data Sin2) in the sensor unit 22 and the environment map 23a. This makes it possible for the aircraft 20 to generate the operation data (the operation signal Oin′) with high accuracy on the basis of the posture data (the rotation matrix mRbody) of the aircraft 20 expressed in the coordinate system of the environment map 23a and the posture data (the rotation matrix mRcnt) of the remote controller 10 expressed in the coordinate system shared with the environment map 23a. This allows the operator OP to intuitively perform the remote operation of the aircraft 20.

### 1. Modification Example of First Embodiment

A description is given below of a modification example of the manipulation system 1 according to the first embodiment described above. Note that in the following, configurations common to the embodiment described above are denoted with the same reference numerals as those of the embodiment described above. In addition, effects common to the embodiment described above are appropriately omitted below.

In the embodiment described above, for example, as illustrated in FIG. 13, a remote controller 30 and a terminal device 40 may be provided instead of the remote controller 10.

The remote controller 30 includes the operation unit 11 and a communication unit 17. The terminal device 40 includes an operation unit 41, the sensor unit 12, the storage unit 13, the SLAM processing unit 14, the communication unit 15, and the display unit 16.

The communication unit 17 acquires the operation signal Oin from the operation unit 11, receives posture data (the rotation matrix mRcnt) of the terminal device 40 from the communication unit 15, and transmits the operation signal Oin and the rotation matrix mRcnt to the aircraft 20. The communication unit 17 receives, from the aircraft 20, the position data Lc2 and the posture data Ps2 of the aircraft 20, and transmits the received position data Lc2 and the received posture data Ps2 to the communication unit 15. The operation unit 41 receives an operation performed on the terminal device 40 by the operator OP, and outputs an operation signal obtained thereby to the communication unit 15.

In the present modification example, a device required to generate posture data (the rotation matrix mRcnt) of the remote controller 30 is provided in the terminal device 40. This makes it possible to configure the remote controller 30 only with a highly general-purpose device, which makes it possible to provide the remote controller 30 at a low cost. In addition, because the remote controller 30 and the terminal device 40 are fixed to each other in a predetermined positional relationship, it is possible to allow the posture data (the rotation matrix mRcnt) of the terminal device 40 to be regarded as the posture data (the rotation matrix mRcnt) of the remote controller 30.

### 3. Second Embodiment

### Configuration

A description is given of a manipulation system 2 according to a second embodiment of the present disclosure. FIG. 15 illustrates a schematic configuration example of the manipulation system 2. The manipulation system 2 differs from the manipulation system 1 in that the manipulation system 2 allows for an intuitive remote operation of an aircraft 60, without the use of the environment map.

For example, as illustrated in FIG. 15, the manipulation system 2 includes the aircraft 60 and a remote controller 50 that remotely operates the aircraft 60.

### [Remote Controller 50]

FIG. 16 illustrates a schematic configuration example of the remote controller 50. The remote controller 50 includes the operation unit 11, the sensor unit 12, a signal processing unit 51, a communication unit 52, and the display unit 16.

The signal processing unit 51 derives a position and a posture of the remote controller 50 on the basis of the sensor data Sin1 obtained from the sensor unit 12. The derived position and posture of the remote controller 50 are expressed in a coordinate system unique to the remote controller 50. For example, the signal processing unit 51 generates the position data Lc1 expressed in the coordinate system unique to the remote controller 50, on the basis of the position data obtained from the positioning meter of the sensor unit 12. For example, the signal processing unit 51 generates the posture data Ps1 and a rotation matrix cnt_intRcnt expressed in the coordinate system unique to the remote controller 50, on the basis of the posture data obtained from the gyro sensor of the sensor unit 12. The signal processing unit 51 outputs the generated position data Lc1, the generated posture data Ps1, and the generated rotation matrix cnt_intRcnt to the communication unit 15. Note that in FIG. 16, the rotation matrix cnt_intRcnt is described as DR1.

Here, in cnt_intRct, cnt_int positioned on left side of R means that it is based on an initial posture of the remote controller 50 as a reference, R means that it is a rotation matrix, and cnt positioned on right side of R means the current posture of the remote controller 50. That is, cnt_intRcnt means that it is a rotation matrix representing an amount of change in the posture of the remote controller 50 in the coordinate system unique to the remote controller 50.

The communication unit 52 transmits, to the aircraft 20, the operation signal Oin generated by the operation unit 11 and the rotation matrix cnt_intRcnt generated by the signal processing unit 51. The communication unit 52 receives, from the aircraft 20, the position data Lc2 and the posture data Ps2 of the aircraft 20. The communication unit 52 outputs, to the display unit 16, the position data Lc1 and the posture data Ps1 of the remote controller 50 and the position data Lc2 and the posture data Ps2 of the aircraft 20.

### [Aircraft 60]

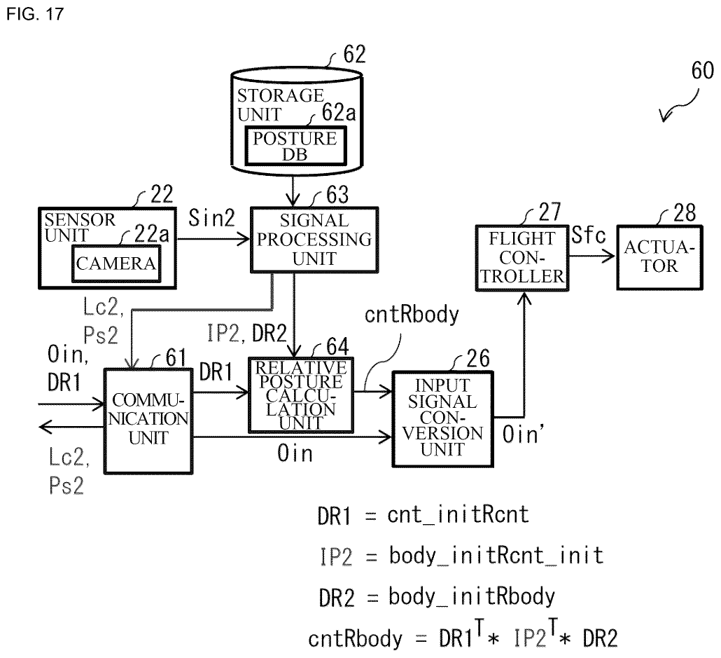

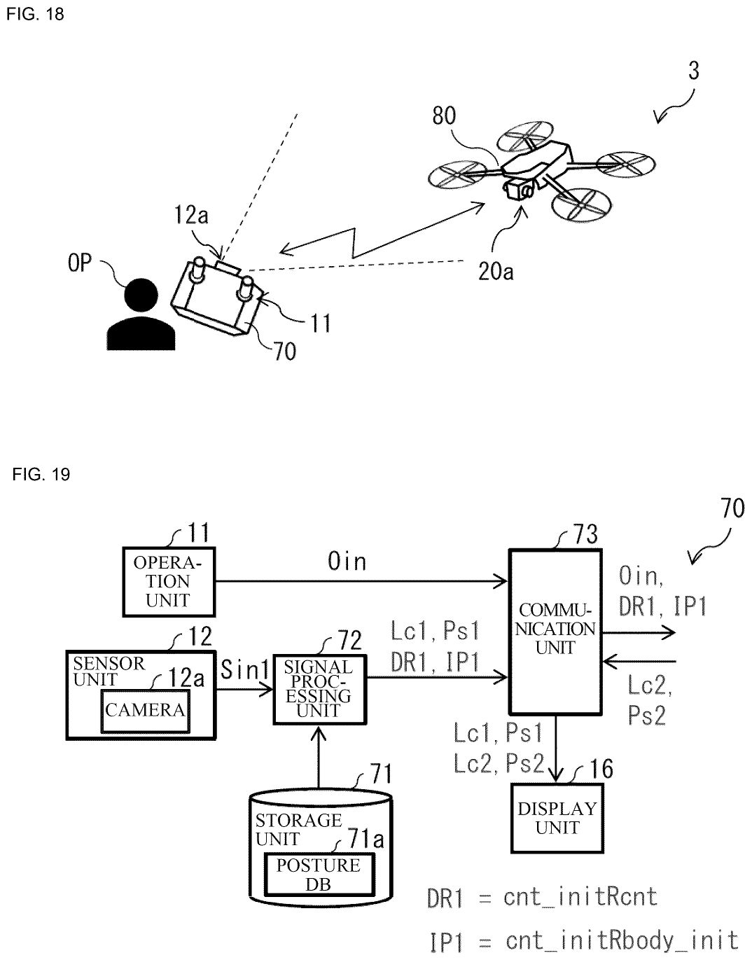

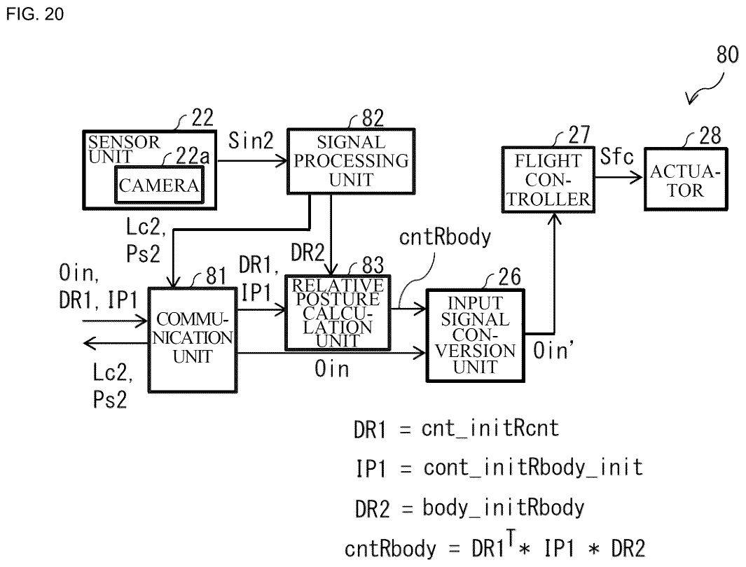

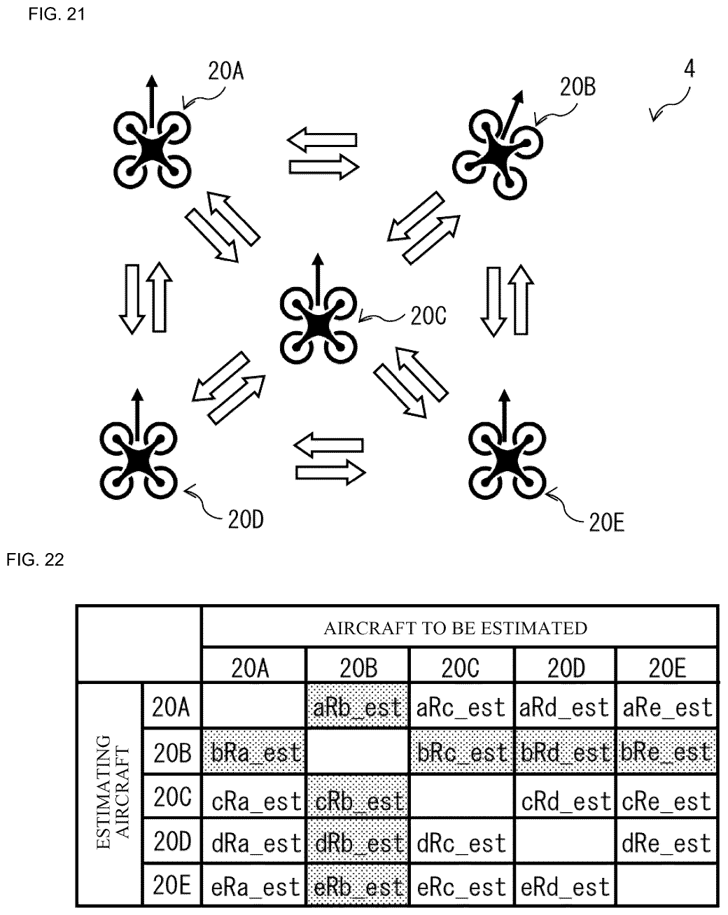

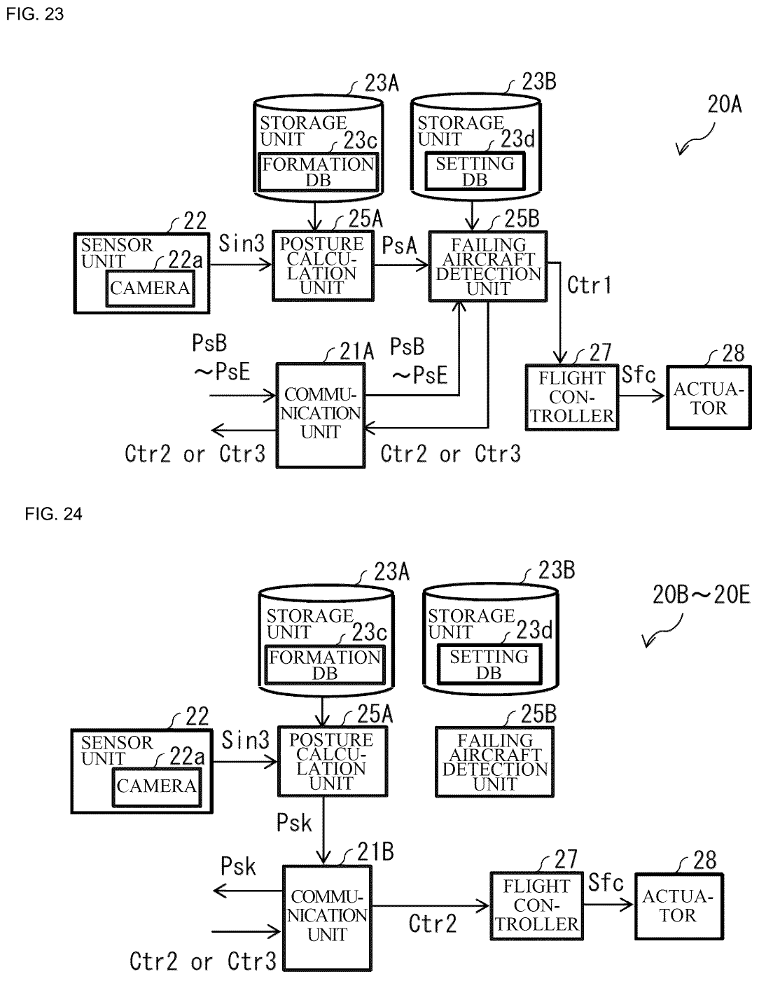

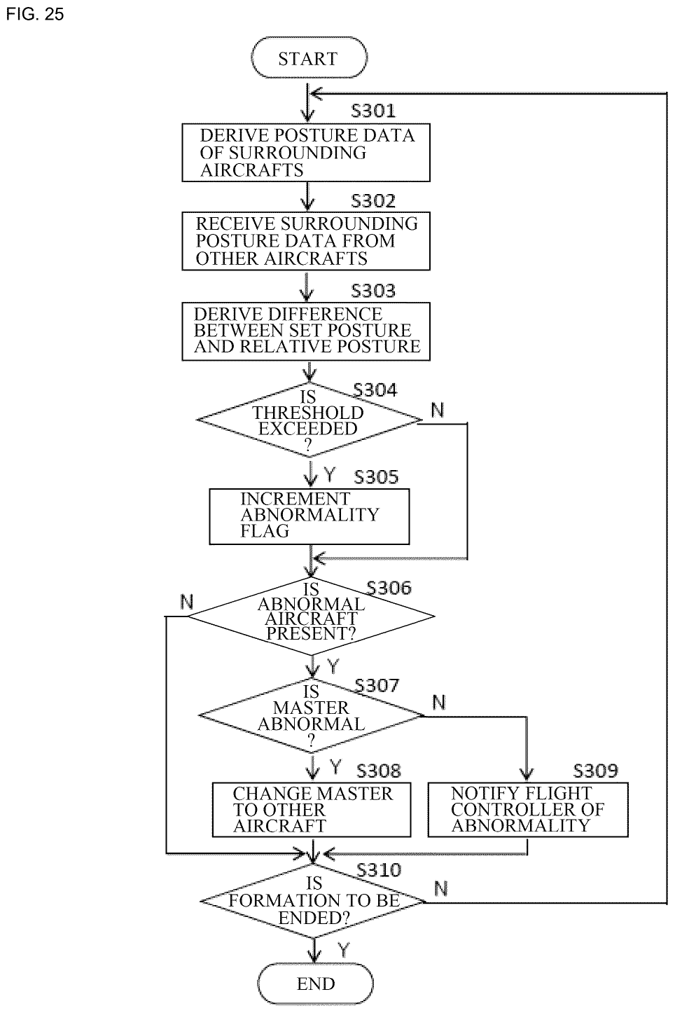

FIG. 17 illustrates a schematic configuration example of the aircraft 60. The aircraft 60 is to be remotely operated by the remote controller 50. The aircraft 60 includes a communication unit 61, the sensor unit 22, a storage unit 62, a signal processing unit 63, a relative posture calculation unit 64, the input signal conversion unit 26, the flight controller 27, and the actuator 28.

The communication unit 61 receives the operation signal Oin and the rotation matrix cnt_intRcnt from the remote controller 50. The communication unit 61 outputs the received operation signal Oin to the input signal conversion unit 26, and outputs the received rotation matrix cnt_intRcnt to the relative posture calculation unit 64. Further, the communication unit 61 acquires the position data Lc2 and the posture data Ps2 of the aircraft 60 from the signal processing unit 63. The communication unit 61 transmits the acquired position data Lc2 and the acquired posture data Ps2 to the remote controller 50.

The sensor unit 22 includes a camera 22a. Examples of the camera 22a include an RGB camera, an RGB-D camera, a depth sensor, an infrared sensor, an event-based camera, and a stereo camera. The sensor unit 22 outputs, to the signal processing unit 63, the senser data Sin2 including image data acquired by the camera 22a.

The storage unit 62 includes, for example, a volatile memory such as a DRAM, or a nonvolatile memory such as an EEPROM or a flash memory. The storage unit 62 holds a posture DB (Data-Base) 62a, for example. The posture DB 62a holds a 2D (dimension) feature (a 2D coordinate value) of a model image (keyframe) of the remote controller 50 or the operator OP, and a 3D feature (a 3D coordinate value) corresponding to the 2D feature (the 2D coordinate value). The storage unit 62 holds a rotation matrix body_intRcnt_int. Note that in FIG. 17, the rotation matrix body_intRcnt_int is described as IP2.

Here, body_intRct_int, body_int positioned on left side of R means that it is based on an initial posture of the aircraft 60 as a reference, R means that it is a rotation matrix, and cnt_int positioned on right side of R means an initial posture of the remote controller 50 or the operator OP. That is, body_intRcnt_int means that it is a rotation matrix representing an initial relative posture of the remote controller 50 or the operator OP with respect to the aircraft 60.

The signal processing unit 63 derives a position and a posture of the aircraft 60 on the basis of the sensor data Sin2 obtained from the sensor unit 22. The derived position and posture of the aircraft 60 are expressed in a coordinate system unique to the aircraft 60. For example, the signal processing unit 63 generates the position data Lc2 expressed in the coordinate system unique to the aircraft 60, on the basis of the position data obtained from the positioning meter of the sensor unit 22. For example, the signal processing unit 63 generates the posture data Ps2 and rotation matrix body_intRbody expressed in the coordinate system unique to the aircraft 60, on the basis of the posture data obtained from the gyro sensor of the sensor unit 22. Note that in FIG. 17, the rotation matrix body_intRbody is described as DR2.

Here, in body_intRbody, body_int positioned on left side of R means that it is based on an initial posture of the aircraft 60 as a reference, R means that it is a rotation matrix, and body positioned on right side of R means a current posture of the aircraft 60. That is, body_intRbody means that it is a rotation matrix representing an amount of change in the posture of the aircraft 60 in the coordinate system unique to the aircraft 60.

For example, the signal processing unit 63 generates a 2D feature of the image data acquired by the camera 22a, by performing predetermined processing on the image data acquired by the camera 22a. For example, the signal processing unit 63 performs matching between the generated 2D feature and the 2D feature of the model image stored in the posture DB 62a, and acquires, from the posture DB 62a, the matched 2D feature and the 3D feature corresponding to the matched 2D feature. For example, the signal processing unit 63 generates an initial relative posture (the rotation matrix body_intRcnt_int) of the remote controller 50 or the operator OP with respect to the aircraft 60, on the basis of the 2D feature and the 3D feature acquired from the posture DB 62a with use of a Perspective-n-Point algorithm.

The signal processing unit 63 outputs the generated position data Lc2 and the generated posture data Ps2 to the communication unit 61, and outputs the generated rotation matrix body_intRbody and the generated rotation matrix body_intRcnt_int to the relative posture calculation unit 64.

The relative posture calculation unit 64 estimates a relative posture of the aircraft 60 with respect to the remote controller 50 on the basis of the rotation matrix cnt_intRcnt inputted from the communication unit 61, and the rotation matrix body_intRbody and the rotation matrix body_intRcnt_int inputted from the signal processing unit 63. The relative posture calculation unit 64 calculates the rotation matrix cntRbody as the relative posture data of the aircraft 60 with respect to the remote controller 50 by using Expression (2), for example. In Expression (2), (cnt_intRcnt)^{T} is a transposed matrix of cnt_intRcnt, and (body_intRcnt_int)^{T} is a transposed matrix of body_intRcnt_int.

$$cntRbody = {( cnt\_intRcnt )}^{T} \times {( body\_intRcnt \_int )}^{T} \times body\_intRbody \qquad ( 2 )$$

The relative posture calculation unit 64 outputs, to the input signal conversion unit 26, the relative posture of the aircraft 60 with respect to the remote controller 50 obtained by the estimation. The relative posture calculation unit 64 outputs, for example, the rotation matrix cntRbody obtained by the calculation to the input signal conversion unit 26.

The input signal conversion unit 26 converts the operation signal Oin inputted from the communication unit 61 into the relative operation signal Oin′ on the basis of the rotation matrix cntRbody inputted from the relative posture calculation unit 25. That is, the input signal conversion unit 26 corrects the operation signal Oin on the basis of the posture data of the remote controller 50 and the posture data of the aircraft 60, and thereby generates the relative operation signal Oin′. The input signal conversion unit 26 outputs the generated relative operation signal Oin′ to the flight controller 27.

The flight controller 27 controls the actuator 28 on the basis of the relative operation signal Oin′ (the operation signal Oin in the normal operation mode). The flight controller 27 generates the control signal sfc on the basis of the relative operation signal Oin′ (the operation signal Oin in the normal operation mode), and outputs the generated control signal sfc to the actuator 28. The actuator 28 causes a propeller of the aircraft 60 to rotate, on the basis of the control signal sfc inputted from the flight controller 27. The flight controller 27 thus performs a posture control of the aircraft 60 on the basis of the relative operation signal Oin′ (the operation signal Oin in the normal operation mode).

In the present embodiment, movement data (the rotation matrix cnt_intRcnt) of the remote controller 50 generated on the basis of the detection result (the sensor data Sin1) in the sensor unit 12 and the operation data (the operation signal Oin) received by the operation unit 11 are received by the aircraft 60. Further, the aircraft 60 converts the operation data (the operation signal Oin) into the operation data (the operation signal Oin′), on the basis of the movement data (the rotation matrix cnt_intRcnt) of the remote controller 50 and the posture data (the rotation matrix body_intRbody) of the aircraft 60 generated on the basis of the detection result (the sensor data Sin2) in the sensor unit 22. This allows the operator OP to intuitively perform the remote operation of the aircraft 60.

In the present embodiment, the relative posture data (the rotation matrix cntRbody) of the aircraft 60 with respect to the remote controller 50 is generated on the basis of the movement data (the rotation matrix cnt_intRcnt and the rotation matrix body_intRcnt_int) of the remote controller 50 and the posture data (the rotation matrix body_intRbody) of the aircraft 60. In addition, the corrected operation data (the operation signal Oin′) is generated on the basis of the generated relative posture data (the rotation matrix cntRbody). This allows the operator OP to intuitively perform the remote operation of the aircraft 60.

In the present embodiment, the posture data (the rotation matrix body_intRbody) of the aircraft 60 is generated on the basis of the detection result (the sensor data Sin2) in the sensor unit 22 and the posture DB 62a. This makes it possible for the aircraft 60 to generate the operation data (the operation signal Oin′) with high accuracy on the basis of the movement data (the rotation matrix cnt_intRcnt and the rotation matrix body_intRcnt_int) of the remote controller 50 and the posture data (the rotation matrix body_intRbody) of the aircraft 60. This allows the operator OP to intuitively perform the remote operation of the aircraft 60.

### 4. Third Embodiment

### Configuration

A description is given of a manipulation system 3 according to a third embodiment of the present disclosure. FIG. 18 illustrates a schematic configuration example of the manipulation system 3. The manipulation system 3 differs from the manipulation system 1 in that the manipulation system 3 allows for an intuitive remote operation of an aircraft 80, without the use of the environment map.

For example, as illustrated in FIG. 18, the manipulation system 2 includes the aircraft 80 and a remote controller 70 that remotely operates the aircraft 80.

### [Remote Controller 70]

FIG. 19 illustrates a schematic configuration example of the remote controller 70. The remote controller 70 includes the operation unit 11, the sensor unit 12, a storage unit 71, a signal processing unit 72, a communication unit 73, and the display unit 16.

The sensor unit 12 includes, for example, a camera 12a. Examples of the camera 12a include an RGB camera, an RGB-D camera, a depth sensor, an infrared sensor, an event-based camera, and a stereo camera. The sensor unit 12 outputs, to the signal processing unit 72, the sensor data Sin1 including image data acquired by the camera 12a.

The storage unit 71 includes, for example, a volatile memory such as a DRAM, or a nonvolatile memory such as an EEPROM or a flash memory. The storage unit 71 holds a posture DB (Data-Base) 71a, for example. The posture DB 71a holds a 2D feature (a 2D coordinate value) of a model image (keyframe) of the aircraft 80, and a 3D feature (a 3D coordinate value) corresponding to the 2D feature (the 2D coordinate value). The storage unit 71 holds a rotation matrix cnt_intRbody_int. Note that in FIG. 19, the rotation matrix cnt_intRbody_int is described as IPL.

Here, in cnt_intRbody_int, cnt_int positioned on left side of R means that it is based on an initial posture of the remote controller 70 as a reference, R means that it is a rotation matrix, and body_int positioned on right side of R means an initial posture of the aircraft 80. That is, cnt_intRbody_int means that it is a rotation matrix representing an initial relative posture of the aircraft 80 with respect to the remote controller 70.

The signal processing unit 72 derives a position and a posture of the remote controller 70 on the basis of the sensor data Sin1 obtained from the sensor unit 12. The derived position and posture of the remote controller 70 are expressed in a coordinate system unique to the remote controller 70. For example, the signal processing unit 72 generates the position data Lc1 expressed in the coordinate system unique to the remote controller 70, on the basis of the position data obtained from the positioning meter of the sensor unit 12. For example, the signal processing unit 72 generates the posture data Ps1 and the rotation matrix cnt_intRcnt expressed in the coordinate system unique to the remote controller 70, on the basis of the posture data obtained from the gyro sensor of the sensor unit 12. Note that in FIG. 19, the rotation matrix cnt_intRcnt is described as DR1.

For example, the signal processing unit 72 generates the 2D feature of the image data acquired by the camera 12a, by performing predetermined processing on the image data acquired by the camera 12a. For example, the signal processing unit 72 performs matching between the generated 2D feature and the 2D feature of the model image stored in the posture DB 71a, and acquires, from the posture DB 71a, the matched 2D feature and the 3D feature corresponding to the matched 2D feature. For example, the signal processing unit 72 generates the initial relative posture (the rotation matrix cnt_intRbody_int) of the aircraft 80 with respect to the remote controller 70, on the basis of the 2D feature and the 3D feature acquired from the posture DB 71a with use of the Perspective-n-Point algorithm.

The signal processing unit 72 outputs the generated position data Lc1 and the generated posture data Ps1 to the communication unit 73, and outputs the generated rotation matrix cnt_intRcnt and the generated rotation matrix cnt_intRbody_int to the communication unit 73.

The communication unit 73 transmits, to the aircraft 80, the operation signal Oin generated by the operation unit 11 and the rotation matrix cnt_intRcnt and the rotation matrix cnt_intRbody_int generated by the signal processing unit 72. The communication unit 73 receives, from the aircraft 80, the position data Lc2 and the posture data Ps2 of the aircraft 80. The communication unit 73 outputs, to the display unit 16, the position data Lc1 and the posture data Ps1 of the remote controller 70 and the position data Lc2 and the posture data Ps2 of the aircraft 80.

### [Aircraft 80]

FIG. 20 illustrates a schematic configuration example of the aircraft 80. The aircraft 80 is to be remotely operated by the remote controller 70. The aircraft 80 includes a communication unit 81, the sensor unit 22, a signal processing unit 82, a relative posture calculation unit 83, the input signal conversion unit 26, the flight controller 27, and the actuator 28.

The communication unit 81 receives the operation signal Oin, the rotation matrix cnt_intRcnt, and the rotation matrix cnt_intRbody_int from the remote controller 70. The communication unit 81 outputs the received operation signal Oin to the input signal conversion unit 26, and outputs the received rotation matrix cnt_intRcnt and the received rotation matrix cnt_intRbody_int to the relative posture calculation unit 83. Further, the communication unit 81 acquires the position data Lc2 and the posture data Ps2 of the aircraft 80 from the signal processing unit 82. The communication unit 81 transmits the acquired position data Lc2 and the acquired posture data Ps2 to the remote controller 70.

The signal processing unit 82 derives a position and a posture of the aircraft 80 on the basis of the sensor data Sin2 obtained from the sensor unit 22. The derived position and posture of the aircraft 80 are expressed in a coordinate system unique to the aircraft 80. For example, the signal processing unit 82 generates position data Lc2 expressed in the coordinate system unique to the aircraft 80, on the basis of the position data obtained from the positioning meter of the sensor unit 22. For example, the signal processing unit 82 generates posture data Ps2 and rotation matrix body_intRbody expressed in the coordinate system unique to the aircraft 80 on the basis of the posture data obtained from the gyro sensor of the sensor unit 22. The signal processing unit 82 outputs the generated position data Lc2, the generated posture data Ps2 to the communication unit 81, and outputs the rotation matrix body_intRbody to the relative posture calculation unit 83.

The relative posture calculation unit 83 estimates a relative posture of the aircraft 80 with respect to the remote controller 70 on the basis of the rotation matrix cnt_intRcnt and the rotation matrix cnt_intRbody_int inputted from the communication unit 81 and the rotation matrix body_intRbody inputted from the signal processing unit 82. The relative posture calculation unit 83 calculates the rotation matrix cntRbody as relative posture data of the aircraft 80 with respect to the remote controller 70 by using Expression (3), for example.

$$cntRbody = {( cnt\_intRcnt )}^{T} \times ( cnt\_intRbody \_int ) \times body\_intRbody \qquad ( 3 )$$

The relative posture calculation unit 83 outputs, to the input signal conversion unit 26, the relative posture of the aircraft 80 with respect to the remote controller 70 obtained by the estimation. The relative posture calculation unit 83 outputs, for example, the rotation matrix cntRbody obtained by the calculation to the input signal conversion unit 26.

The input signal conversion unit 26 converts the operation signal Oin inputted from the communication unit 81 into the relative operation signal Oin′ on the basis of the rotation matrix cntRbody inputted from the relative posture calculation unit 83. That is, the input signal conversion unit 26 corrects the operation signal Oin on the basis of the posture data of the remote controller 70 and the posture data of the aircraft 80, and thereby generates the relative operation signal Oin′. The input signal conversion unit 26 outputs the generated relative operation signal Oin′ to the flight controller 27.

The flight controller 27 generates the control signal sfc on the basis of the relative operation signal Oin′ (the operation signal Oin in the normal operation mode), and outputs the generated control signal sfc to the actuator 28. The actuator 28 causes a propeller of the aircraft 80 to rotate, on the basis of the control signal sfc inputted from the flight controller 27. The flight controller 27 thus performs a posture control of the aircraft 80 on the basis of the relative operation signal Oin′ (the operation signal Oin in the normal operation mode).

In the present embodiment, the posture data (the rotation matrix cnt_intRcnt and the rotation matrix cnt_intRbody_int) generated on the basis of the detection result (the sensor data Sin1) in the sensor unit 12 and the operation data (the operation signal Oin) received by the operation unit 11 are received by the aircraft 80. Further, the aircraft 80 converts the operation data (the operation signal Oin) into the operation data (the operation signal Oin′), on the basis of movement data (the rotation matrix cnt_intRcnt) of the remote controller 70 and movement data (the rotation matrix cnt_intRbody_int and the rotation matrix body_intRbody) of the aircraft 80. This allows the operator OP to intuitively perform a remote operation of the aircraft 80.

In the present embodiment, the relative posture data (the rotation matrix cntRbody) of the aircraft 80 with respect to the remote controller 70 is generated on the basis of the movement data (the rotation matrix cnt_intRcnt) of the remote controller 70 and the posture data (the rotation matrix body_intRcnt_int and the rotation matrix body_intRbody) of the aircraft 80. In addition, the corrected operation data (the data operation signal Oin′ for operating the relative posture of the aircraft 80 viewed from the remote controller 70) is generated on the basis of the generated relative posture data (the rotation matrix cntRbody). This allows the operator OP to intuitively perform the remote operation of the aircraft 80.

In the present embodiment, the posture data (the rotation matrix cnt_intRbody) of the aircraft 80 is generated on the basis of the detection result (the sensor data Sin1) in the sensor unit 12 and the posture DB 71a. This makes it possible for the aircraft 80 to generate the operation data (the operation signal Oin′) with high accuracy on the basis of the movement data (the rotation matrix cnt_intRcnt) of the remote controller 70 and the posture data (the rotation matrix cnt_intRbody_int and the rotation matrix cnt_intRbody) of the aircraft 80. This allows the operator OP to intuitively perform the remote operation of the aircraft 80.

### 5. Fourth Embodiment

### Configuration

A description is given of a manipulation system 4 according to a fourth embodiment of the present disclosure. FIG. 21 illustrates a schematic configuration example of the manipulation system 4. The manipulation system 4 includes a plurality of aircrafts 20A, 20B, 20C, 20D, and 20E in formation. In the manipulation system 4, each of the aircrafts 20A to 20E estimates a posture or respective postures of one or more other aircrafts, and the aircraft 20A serving as a master determines whether or not each of the aircrafts 20A to 20E is abnormal in posture on the basis of an estimation result (an estimated posture) obtained by each of the aircrafts 20A to 20E.

For example, the aircraft 20A serving as the master acquires the estimated posture of each of the aircrafts 20A to 20E from each of the aircrafts 20A to 20E. Further, for example, the aircraft 20A serving as the master derives a difference (a posture error) between the acquired estimated posture of each of the aircrafts 20A to 20E and a set posture of corresponding one of the aircrafts 20A to 20E, and determines whether or not the derived posture error exceeds a predetermined threshold.

FIG. 22 is a table describing an example of posture errors derived by the aircraft 20A serving as the master. In FIG. 22, a dotted background indicates that the posture error presented at the location exceeds the predetermined threshold.

In FIG. 22, it is suggested that the posture of each of the other aircrafts estimated by the aircraft 20B and the posture of the aircraft 20B estimated by each of the aircrafts 20A and 20C to 20E are abnormal. On the basis of the above, it is found that the aircraft 20B is abnormal in posture. For example, the following method is one example method of determining that the aircraft 20B is abnormal in posture by a calculation on the basis of the table in FIG. 22.

Specifically, one point is given to the aircraft determined to be abnormal in posture by the above-described threshold determination. Further, one point is given to the aircraft that has estimated the posture of the aircraft determined to be abnormal in posture by the above-described threshold determination. The aircraft that is the largest in total value of the points obtained as a result is determined to be abnormal in posture. The aircraft 20A, which serves as the master, performing a calculation by the above-described determination method makes it possible to determine the aircraft that is abnormal in posture. A description is given below of a configuration example of each of the aircrafts 20A to 20E to implement this.

FIG. 23 illustrates a schematic configuration example of the aircraft 20A serving as the master. FIG. 24 illustrates a schematic configuration example of each of the aircrafts 20B to 20E serving as slaves.

### [Aircraft 20A as Master]

For example, as illustrated in FIG. 23, the aircraft 20A includes a communication unit 21A, the sensor unit 22, storage units 23A and 23B, a posture calculation unit 25A, a failing aircraft detection unit 25B, the flight controller 27, and the actuator 28.

The communication unit 21A receives respective pieces of posture data PsB to PsE from the aircrafts 20B to 20E serving as the slaves, and outputs the received pieces of posture data PsB to PsE to the failing aircraft detection unit 25B. The posture data PsB is posture data of the aircrafts 20A and 20C to 20E obtained from the aircraft 20B. The posture data PsC is posture data of the aircrafts 20A, 20B, 20D, and 20E obtained from the aircraft 20C. The posture data PsC is posture data of the aircrafts 20A, 20B, 20D, and 20E obtained from the aircraft 20C. The posture data PsD is posture data of the aircrafts 20A to 20C and 20E obtained from the aircraft 20D. The posture data PsE is posture data of the aircrafts 20A to 20D obtained from the aircraft 20E.

When the communication unit 21A acquires, from the failing aircraft detection unit 25B, an abnormality notification Ctr2 to be transmitted to the aircraft determined as being abnormal in posture, the communication unit 21A transmits the acquired abnormality notification Crt2 to the aircraft determined as being abnormal in posture. When the communication unit 21A acquires a master change notification Ctr3 to be transmitted to a particular slave from the failing aircraft detection unit 25B from the failing aircraft detection unit 25B, the communication unit 21A transmits the acquired master change notification Ctr3 to a particular slave.

The sensor unit 22 detects a position and a posture of the aircraft 20A. The sensor unit 22 includes a positioning meter, for example. The positioning meter receives a GNSS signal from a GNSS satellite (e.g., a GPS signal from a GPS satellite), executes positioning, and generates position data including a latitude, a longitude, and an altitude of the aircraft 20A. The sensor unit 22 further includes a gyro sensor, for example. The gyro sensor detects an angular velocity of the aircraft 20A, and generates posture data of the aircraft 20A on the basis of the detected angular velocity.

The sensor unit 22 includes the camera 22a. Examples of the camera 22a include an RGB camera, an RGB-D camera, a depth sensor, an infrared sensor, an event-based camera, and a stereo camera. The camera 22a captures an image of the one or more other aircrafts in formation. The sensor unit 22 outputs, to the posture calculation unit 25A, senser data Sin3 including the position data and the posture data of the aircraft 20A and image data acquired by the camera 22a.

The storage unit 23A includes, for example, a volatile memory such as a DRAM, or a nonvolatile memory such as an EEPROM or a flash memory. The storage unit 23A holds a formation DB (Data-Base) 23c, for example. In the formation DB 23c, a feature and the posture data PsA are associated with each other for each of various postures of aircrafts that may be included in the image data acquired by the camera 22a.

The storage unit 23B includes, for example, a volatile memory such as a DRAM, or a nonvolatile memory such as an EEPROM or a flash memory. The storage unit 23B holds a setting DB (Data-Base) 23d, for example. The setting DB 23d holds setting data regarding the posture of each of the aircrafts 20A to 20E when the aircrafts 20A to 20E are in formation.

The posture calculation unit 25A generates a feature of the image data included in the sensor data Sin3 obtained from the sensor unit 22. The posture calculation unit 25A compares the generated feature and each of the features stored in the formation DB 23c with each other, and reads, from the formation DB 23c, the posture data PsA corresponding to the feature that has matched as a result of the comparison. The posture calculation unit 25A outputs, to the failing aircraft detection unit 25B, the posture data PsA read from the formation DB 23c. The posture data PsA is the posture data of the aircrafts 20B to 20E obtained by the posture calculation unit 25A. The posture calculation unit 25A thus detects the posture or postures of the one or more other aircrafts, and generates the posture data of the one or more other aircrafts that have been detected.

Here, the posture data PsA acquired from the posture calculation unit 25A and the pieces of posture data PsB to PsE acquired from the other aircrafts 20B to 20E via the communication unit 21A are each referred to as an estimated posture. Further, the posture data read from the setting DB 23d is referred to as a set posture. In this case, the failing aircraft detection unit 25B detects an aircraft that is abnormal in posture, on the basis of the estimated posture and the set posture. Specifically, the failing aircraft detection unit 25B derives a difference (a posture error) between the estimated posture and the set posture, determines whether or not the derived posture error exceeds a predetermined threshold, and detects the aircraft that is abnormal in posture on the basis of a result of the determination.

In a case where the derived posture error exceeds the predetermined threshold as a result, the failing aircraft detection unit 25B increments an abnormality flag by one for the aircraft corresponding to the estimated posture exceeding the predetermined threshold. The failing aircraft detection unit 25B further increments the abnormality flag by one for the aircraft that has generated the estimated posture exceeding the predetermined threshold. The failing aircraft detection unit 25B determines that the aircraft that is the largest in value of the abnormality flag as a result is abnormal in posture.

In a case where the aircraft determined as being abnormal in posture is the slave, the failing aircraft detection unit 25B generates the abnormality notification Ctr2 to be transmitted to that slave, and outputs the generated abnormality notification Ctr2 to the communication unit 21A. In a case where the aircraft determined as being abnormal in posture is the master, the failing aircraft detection unit 25B generates the master change notification Ctr3 to be transmitted to the particular slave, and outputs the generated master change notification Ctr3 to the communication unit 21A. At this time, further, the failing aircraft detection unit 25B transmits an abnormality notification Ctr1 to the flight controller 27.

For example, the flight controller 27 generates the control signal sfc on the basis of the inputted operation signal, and outputs the generated control signal sfc to the actuator 28. For example, in a case where the flight controller 27 acquires the abnormality notification Ctr1 from the failing aircraft detection unit 25B, the flight controller 27 generates the control signal sfc for stopping a formation flight and allowing for return to a predetermined base station, and outputs the generated control signal sfc to the actuator 28. The actuator 28 causes a propeller of the aircraft 60 to rotate, on the basis of the control signal sfc inputted from the flight controller 27. The flight controller 27 thus performs a posture control of the aircraft 20A on the basis of the inputted operation signal.

### [Aircrafts 20B to 20E as Slaves]

For example, as illustrated in FIG. 24, the aircrafts 20B to 20E serving as the slaves each include a communication unit 21B, the sensor unit 22, the storage units 23A and 23B, the posture calculation unit 25A, the failing aircraft detection unit 25B, the flight controller 27, and the actuator 28.

When the communication unit 21B acquires posture data Psk (any piece of data among PsB to PsE) from the posture calculation unit 25A, the communication unit 21B transmits the acquired posture data Psk to the master. When the communication unit 21B receives the abnormality notification Ctr2 from the master, the communication unit 21B outputs the received abnormality notification Ctr2 to the flight controller 27. When the communication unit 21B receives the master change notification Ctr3 from the master, the communication unit 21B outputs the received master change notification Ctr3 to the posture calculation unit 25A and the failing aircraft detection unit 25B.

The sensor unit 22 detects a position and a posture of an own aircraft. The sensor unit 22 includes a positioning meter, for example. The positioning meter receives a GNSS signal from a GNSS satellite (e.g., a GPS signal from a GPS satellite), executes positioning, and generates position data including a latitude, a longitude, and an altitude of the own aircraft. The sensor unit 22 further includes a gyro sensor, for example. The gyro sensor detects an angular velocity of the own aircraft and generates posture data of the own aircraft on the basis of the detected angular velocity.

The sensor unit 22 includes the camera 22a. Examples of the camera 22a include an RGB camera, an RGB-D camera, a depth sensor, an infrared sensor, an event-based camera, and a stereo camera. The camera 22a captures an image of the one or more other aircrafts in formation. The sensor unit 22 outputs, to the posture calculation unit 25A, the senser data Sin3 including the position data and the posture data of the own aircraft and the image data acquired by the camera 22a.

The storage unit 23A includes, for example, a volatile memory such as a DRAM, or a nonvolatile memory such as an EEPROM or a flash memory. The storage unit 23A holds the formation DB 23c, for example. In the formation DB 23C, a feature and the posture data Psk are associated with each other for each of various postures of aircrafts that may be included in the image data acquired by the camera 22a.

The storage unit 23B includes, for example, a volatile memory such as a DRAM, or a nonvolatile memory such as an EEPROM or a flash memory. The storage unit 23B holds the setting DB 23d, for example. The setting DB 23d holds the setting data regarding the posture of each of the aircrafts 20A to 20E when the aircrafts 20A to 20E are in formation.

The posture calculation unit 25A generates a feature of the image data included in the sensor data Sin3 obtained from the sensor unit 22. The posture calculation unit 25A compares the generated feature and each of the features stored in the formation DB 23c with each other, and reads, from the formation DB 23c, the posture data Psk corresponding to the feature that has matched as a result of the comparison. The posture calculation unit 25A outputs, to the communication unit 21B, the posture data Psk read from the formation DB 23c. The posture calculation unit 25A thus detects the posture or postures of the one or more other aircrafts, and generates the posture data of the one or more other aircrafts that have been detected.

When the posture calculation unit 25A acquires the master change notification Ctr3 from the communication unit 21B, the posture calculation unit 25A behaves as the master. Specifically, the posture calculation unit 25A outputs the posture data Psk to the failing aircraft detection unit 25B.

When the failing aircraft detection unit 25B acquires the master change notification Ctr3 from the communication unit 21B, the failing aircraft detection unit 25B behaves as the master. Specifically, the failing aircraft detection unit 25B detects an aircraft that is abnormal in posture, on the basis of the estimated posture and the set posture. The failing aircraft detection unit 25B derives a difference (a posture error) between the estimated posture and the set posture, determines whether or not the derived posture error exceeds a predetermined threshold, and detects the aircraft that is abnormal in posture on the basis of a result of the determination.

In a case where the derived posture error exceeds the predetermined threshold as a result, the failing aircraft detection unit 25B increments an abnormality flag by one for the aircraft corresponding to the estimated posture exceeding the predetermined threshold. The failing aircraft detection unit 25B further increments the abnormality flag by one for the aircraft that has generated the estimated posture exceeding the predetermined threshold. The failing aircraft detection unit 25B determines that the aircraft that is the largest in value of the abnormality flag as a result is abnormal in posture.

In a case where the aircraft determined as being abnormal in posture is the slave, the failing aircraft detection unit 25B generates the abnormality notification Ctr2 to be transmitted to that slave, and outputs the generated abnormality notification Ctr2 to the communication unit 21A. In a case where the aircraft determined as being abnormal in posture is the master, the failing aircraft detection unit 25B generates the master change notification Ctr3 to be transmitted to the particular slave, and outputs the generated master change notification Ctr3 to the communication unit 21A. At this time, further, the failing aircraft detection unit 25B transmits the abnormality notification Ctr1 to the flight controller 27.

### [Operation]

Next, a description is given of an operation of the aircraft 20A serving as the master in the manipulation system 4.

FIG. 25 illustrates an example of a posture abnormality determination process in the aircraft 20A serving as the master. First, the posture calculation unit 25A of the master derives the posture data PsA of the aircrafts 20B to 20E around the master, on the basis of the sensor data Sin3 obtained from the sensor unit 22 and the formation DB 23c (step S301). The posture calculation unit 25A of the master outputs the derived posture data PsA to the failing aircraft detection unit 25B.

Further, the communication unit 21A of the master receives the respective pieces of posture data PsB to PsE from the aircrafts 20B to 20E serving as the slaves (step S302). The communication unit 21A of the master outputs the received pieces of posture data PsB to PsE to the failing aircraft detection unit 25B.

The failing aircraft detection unit 25B derives a difference (a posture error) between each of the estimated postures of the aircrafts 20A to 20E derived by the master and the slaves and the set posture read from the setting DB 23d (step S303). The failing aircraft detection unit 25B determines whether or not the derived posture error exceeds the predetermined threshold (step S304).

In a case where the derived posture error exceeds the predetermined threshold as a result (step S304; Y), the failing aircraft detection unit 25B increments the abnormality flag by one for the aircraft corresponding to the estimated posture exceeding the predetermined threshold (step S305). The failing aircraft detection unit 25B further increments the abnormality flag by one for the aircraft that has generated the estimated posture exceeding the predetermined threshold (step S305). In contrast, in a case where the derived posture error does not exceed the predetermined threshold (step S304; N), the failing aircraft detection unit 25B does not increment the abnormality flag for the aircraft corresponding to the estimated posture that does not exceed the predetermined threshold.

The failing aircraft detection unit 25B determines whether or not an aircraft that is abnormal in posture is present, on the basis of the values of the abnormality flags (step S306). For example, in a case where the values of the abnormality flags exceed the predetermined threshold, the failing aircraft detection unit 25B determines that the aircraft that is the largest in the value of the abnormality flag is abnormal in posture (step S306; Y). For example, in a case where the values of the abnormality flags do not exceed the predetermined threshold, the failing aircraft detection unit 25B determines that no aircraft is abnormal in posture (step S306; N).

The failing aircraft detection unit 25B determines whether or not the aircraft that is abnormal in posture is the master (step S307). In a case where the aircraft that is abnormal in posture is the master as a result (step S307; Y), the failing aircraft detection unit 25B generates the master change notification Ctr3, and changes the master to another aircraft. In a case where the aircraft that is abnormal in posture is the salve (step S307; N), the failing aircraft detection unit 25B notifies the flight controller 27 of the abnormality (step S309).

In a case where a notification to end the formation is issued, the aircraft 20A serving as the master ends the formation (step S310; Y). In contrast, in a case where the notification to end the formation is not issued, the aircraft 20A serving as the master continues to execute steps S301 to S309 (step S310; N).

In the present embodiment, whether or not each of the aircrafts 20A to 20E is abnormal in posture is determined on the basis of the respective estimated postures of the aircrafts 20A to 20E obtained on the basis of the image data of the camera 22a. Specifically, whether or not each of the aircrafts 20A to 20E is abnormal in posture is determined by determining whether or not the difference (the posture error) between the above-described estimated posture and the set posture in the setting DB 23d exceeds the predetermined threshold. This allows for, for example, automatic detection of the aircraft that is abnormal in posture. It is therefore possible to stop the aircraft that is abnormal in posture, before the aircraft that is abnormal in posture causes an unexpected event.

Note that the effects described herein are mere examples. Effects of the present disclosure are not limited to the effects described herein. The present disclosure may have effects other than the effects described herein.

In addition, the present disclosure may have any of the following configurations, for example.

(1)

A control device that remotely operates a mobile body, the control device including:
an operation unit that performs reception of an operation for the mobile body;
a sensor unit that performs detection of a posture of the control device or the mobile body;
a generation unit that generates posture data of the control device on the basis of a result of the detection performed by the sensor unit; and
a communication unit that transmits, to the mobile body, the posture data generated by the generation unit and operation data obtained by the reception performed by the operation unit.
   (2)

The control device according to (1), further including
a storage unit in which an environment map is stored, in which
the generation unit generates the posture data of the control device expressed in a coordinate system of the environment map, on the basis of the result of the detection regarding the posture of the control device performed by the sensor unit and the environment map.
   (3)

The control device according to (1) or (2), further including
a storage unit in which a database regarding the posture of the mobile body is stored, in which
the generation unit generates the posture data of the control device on the basis of the result of the detection regarding the posture of the mobile body performed by the sensor unit and the database.
   (4)

The control device according to any one of (1) to (3), further including a display unit that displays at least an orientation of the mobile body, out of the orientation of the mobile body and an orientation of the control device, on the basis of the posture data of the control device and posture data of the mobile body acquired from the mobile body via the communication unit.

(5)

A mobile body to be remotely operated by a control device, the mobile body including:
a sensor unit that performs detection of a posture of the mobile body;
a generation unit that generates posture data of the mobile body on the basis of a result of the detection performed by the sensor unit;
a communication unit that receives posture data of the control device and operation data of the mobile body from the control device;
a correction unit that performs correction on the operation data of the mobile body received by the communication unit, on the basis of the posture data of the control device received by the communication unit and the posture data of the mobile body generated by the generation unit, and thereby generates corrected operation data; and
a control unit that controls an actuator on the basis of the corrected operation data generated by the correction performed by the correction unit.
   (6)

The mobile body according to (5), further including
an estimation unit that estimates relative posture data of the mobile body with respect to the control device, on the basis of the posture data of the control device received by the communication unit and the posture data of the mobile body generated by the generation unit, in which
the correction unit generates the corrected operation data on the basis of the relative posture data estimated by the estimation unit.
   (7)

The mobile body according to (5) or (6), further including
a storage unit in which an environment map is stored, in which
the generation unit generates the posture data of the mobile body expressed in a coordinate system of the environment map, on the basis of the result of the detection performed by the sensor unit and the environment map.
   (8)

A mobile body to be remotely operated by a control device, the mobile body including:
a sensor unit that performs detection of a posture of the control device or an object in a corresponding relationship with the control device;
a generation unit that generates posture data of the mobile body on the basis of a result of the detection performed by the sensor unit;
a communication unit that receives movement data of the control device and operation data of the mobile body from the control device;
a correction unit that performs correction on the operation data of the mobile body received by the communication unit, on the basis of the movement data of the control device received by the communication unit and the posture data of the mobile body generated by the generation unit, and thereby generates corrected operation data; and
a control unit that controls an actuator on the basis of the corrected operation data generated by the correction performed by the correction unit.
   (9)

The mobile body according to (8), further including
an estimation unit that estimates relative posture data of the mobile body with respect to the control device, on the basis of the movement data of the control device received by the communication unit and the posture data of the mobile body generated by the generation unit, in which
the correction unit generates the corrected operation data on the basis of the relative posture data estimated by the estimation unit.
   (10)

The mobile body according to (8) or (9), further including
a storage unit in which a database regarding a posture of the mobile body corresponding to the posture of the control device is stored, in which
the generation unit generates the posture data of the mobile body, on the basis of the result of the detection regarding the posture of the control device or the object performed by the sensor unit and the database.
   (11)

A manipulation system including:
a mobile body; and
a control device that remotely operates the mobile body, in which
the control device includes
   an operation unit that performs reception of an operation for the mobile body,
   a first sensor unit that performs detection of a posture of the control device,
   a first generation unit that generates posture data of the control device on the basis of a result of the detection performed by the first sensor unit, and
   a first communication unit that transmits, to the mobile body, the posture data generated by the first generation unit and operation data obtained by the reception performed by the operation unit, and
the mobile body includes
   a second sensor unit that performs detection of a posture of the mobile body,
   a second generation unit that generates posture data of the mobile body on the basis of a result of the detection performed by the second sensor unit,
   a second communication unit that receives the posture data of the control device and the operation data of the mobile body from the control device,
   a correction unit that performs correction on the operation data of the mobile body received by the second communication unit, on the basis of the posture data of the control device received by the second communication unit and the posture data of the mobile body generated by the second generation unit, and thereby generates corrected operation data, and
   a driving unit that drives an actuator on the basis of the corrected operation data generated by the correction performed by the correction unit.
      (12)

A manipulation system including:
a mobile body; and
a control device that remotely operates the mobile body, in which the control device includes
   an operation unit that performs reception of an operation for the mobile body,
   a first sensor unit that performs detection of a posture of the mobile body,
   a first generation unit that generates posture data of the control device on the basis of a result of the detection performed by the first sensor unit, and
   a first communication unit that transmits, to the mobile body, the posture data generated by the first generation unit and operation data obtained by the reception performed by the operation unit, and
the mobile body includes
   a second sensor unit that performs detection of a posture of the control device or an object in a corresponding relationship with the control device,
   a second generation unit that generates posture data of the mobile body on the basis of a result of the detection performed by the second sensor unit,
   a second communication unit that receives movement data of the control device and the operation data of the mobile body from the control device,
   a correction unit that performs correction on the operation data of the mobile body received by the second communication unit, on the basis of the movement data of the control device received by the second communication unit and the posture data of the mobile body generated by the second generation unit, and thereby generates corrected operation data, and
   a driving unit that drives an actuator on the basis of the corrected operation data generated by the correction performed by the correction unit.
      (13)

A formation system including
a plurality of mobile bodies, in which
a first mobile body that is a slave and is included in the plurality of mobile bodies includes
   a first sensor unit that performs detection of a posture of each of one or more second mobile bodies other than the first mobile body, out of the plurality of mobile bodies,
   a first generation unit that generates posture data of each of the one or more second mobile bodies on the basis of a result of the detection performed by the first sensor unit, and
   a first communication unit that transmits the posture data of each of the one or more second mobile bodies generated by the first generation unit to a third mobile body that is a master and is included in the plurality of mobile bodies, and
the third mobile body includes
   a second sensor unit that performs detection of a posture of each of one or more fourth mobile bodies other than the third mobile body, out of the plurality of mobile bodies,
   a second generation unit that generates posture data of each of the one or more fourth mobile bodies on the basis of a result of the detection performed by the second sensor unit, and
   a detection unit that performs detection of an aircraft that is abnormal in posture, on the basis of the posture data of each of the one or more second mobile bodies received from the first communication unit and the posture data of each of the one or more fourth mobile bodies generated by the second generation unit.

The present application claims the benefit of Japanese Priority Patent Application JP2022-109345 filed with the Japan Patent Office on Jul. 6, 2022, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A control device that remotely operates a mobile body, the control device comprising:
an operation unit that performs reception of an operation for the mobile body;
a sensor unit that performs detection of a posture of the control device or the mobile body;
a generation unit that generates posture data of the control device on a basis of a result of the detection performed by the sensor unit; and
a communication unit that transmits, to the mobile body, the posture data generated by the generation unit and operation data obtained by the reception performed by the operation unit.

2. The control device according to claim 1, further comprising
a storage unit in which an environment map is stored, wherein
the generation unit generates the posture data of the control device expressed in a coordinate system of the environment map, on a basis of the result of the detection regarding the posture of the control device performed by the sensor unit and the environment map.

3. The control device according to claim 1, further comprising
a storage unit in which a database regarding the posture of the mobile body is stored, wherein
the generation unit generates the posture data of the control device on a basis of the result of the detection regarding the posture of the mobile body performed by the sensor unit and the database.

4. The control device according to claim 1, further comprising a display unit that displays at least an orientation of the mobile body, out of the orientation of the mobile body and an orientation of the control device, on a basis of the posture data of the control device and posture data of the mobile body acquired from the mobile body via the communication unit.

5. A mobile body to be remotely operated by a control device, the mobile body comprising:
a sensor unit that performs detection of a posture of the mobile body;
a generation unit that generates posture data of the mobile body on a basis of a result of the detection performed by the sensor unit;
a communication unit that receives posture data of the control device and operation data of the mobile body from the control device;
a correction unit that performs correction on the operation data of the mobile body received by the communication unit, on a basis of the posture data of the control device received by the communication unit and the posture data of the mobile body generated by the generation unit, and thereby generates corrected operation data; and
a control unit that controls an actuator on a basis of the corrected operation data generated by the correction performed by the correction unit.

6. The mobile body according to claim 5, further comprising
an estimation unit that estimates relative posture data of the mobile body with respect to the control device, on a basis of the posture data of the control device received by the communication unit and the posture data of the mobile body generated by the generation unit, wherein
the correction unit generates the corrected operation data on a basis of the relative posture data estimated by the estimation unit.

7. The mobile body according to claim 5, further comprising
a storage unit in which an environment map is stored, wherein
the generation unit generates the posture data of the mobile body expressed in a coordinate system of the environment map, on a basis of the result of the detection performed by the sensor unit and the environment map.

8. A mobile body to be remotely operated by a control device, the mobile body comprising:
a sensor unit that performs detection of a posture of the control device or an object in a corresponding relationship with the control device;
a generation unit that generates posture data of the mobile body on a basis of a result of the detection performed by the sensor unit;
a communication unit that receives movement data of the control device and operation data of the mobile body from the control device;
a correction unit that performs correction on the operation data of the mobile body received by the communication unit, on a basis of the movement data of the control device received by the communication unit and the posture data of the mobile body generated by the generation unit, and thereby generates corrected operation data; and
a control unit that controls an actuator on a basis of the corrected operation data generated by the correction performed by the correction unit.

9. The mobile body according to claim 8, further comprising
an estimation unit that estimates relative posture data of the mobile body with respect to the control device, on a basis of the movement data of the control device received by the communication unit and the posture data of the mobile body generated by the generation unit, wherein
the correction unit generates the corrected operation data on a basis of the relative posture data estimated by the estimation unit.

10. The mobile body according to claim 8, further comprising
a storage unit in which a database regarding a posture of the mobile body corresponding to the posture of the control device is stored, wherein
the generation unit generates the posture data of the mobile body, on a basis of the result of the detection regarding the posture of the control device or the object performed by the sensor unit and the database.

11. A manipulation system comprising:
a mobile body; and
a control device that remotely operates the mobile body, wherein
the control device includes
an operation unit that performs reception of an operation for the mobile body,
a first sensor unit that performs detection of a posture of the control device,
a first generation unit that generates posture data of the control device on a basis of a result of the detection performed by the first sensor unit, and
a first communication unit that transmits, to the mobile body, the posture data generated by the first generation unit and operation data obtained by the reception performed by the operation unit, and
the mobile body includes
a second sensor unit that performs detection of a posture of the mobile body,
a second generation unit that generates posture data of the mobile body on a basis of a result of the detection performed by the second sensor unit,
a second communication unit that receives the posture data of the control device and the operation data of the mobile body from the control device,
a correction unit that performs correction on the operation data of the mobile body received by the second communication unit, on a basis of the posture data of the control device received by the second communication unit and the posture data of the mobile body generated by the second generation unit, and thereby generates corrected operation data, and
a driving unit that drives an actuator on a basis of the corrected operation data generated by the correction performed by the correction unit.

12. A manipulation system comprising:
a mobile body; and
a control device that remotely operates the mobile body, wherein
the control device includes
an operation unit that performs reception of an operation for the mobile body,
a first sensor unit that performs detection of a posture of the mobile body,
a first generation unit that generates posture data of the control device on a basis of a result of the detection performed by the first sensor unit, and
a first communication unit that transmits, to the mobile body, the posture data generated by the first generation unit and operation data obtained by the reception performed by the operation unit, and
the mobile body includes
a second sensor unit that performs detection of a posture of the control device or an object in a corresponding relationship with the control device,
a second generation unit that generates posture data of the mobile body on a basis of a result of the detection performed by the second sensor unit,
a second communication unit that receives movement data of the control device and the operation data of the mobile body from the control device,
a correction unit that performs correction on the operation data of the mobile body received by the second communication unit, on a basis of the movement data of the control device received by the second communication unit and the posture data of the mobile body generated by the second generation unit, and thereby generates corrected operation data, and
a driving unit that drives an actuator on a basis of the corrected operation data generated by the correction performed by the correction unit.
